(19) United States
(12) Patent Application Publication
(10) Pub. No.: US 2004/0047935 A1
(43) Pub. Date: Mar. 11, 2004

(54) Apparatus and method for simulating an injection molding process

(75) Inventors: Mark Moss, Boxford, MA (US); Christopher Czeczuga, West Newburyport, MA (US)

Correspondence Address: KUDIRKA & JOBSE, LLP, ONE STATE STREET, SUITE 800, BOSTON, MA, 02109, US

(73) Assignee: Synventive Molding Solutions, Inc., Peabody, MA

(21) Appl. No.: 10/403,833

(22) Filed: Mar. 31, 2003

Related U.S. Application Data
(63) Continuation-in-part of application No. 09/063,762, filed on Apr. 21, 1998, now Pat. No. 6,361,300.
(63) Continuation-in-part of application No. 10/144,480, filed on May 13, 2002, now Pat. No. 6,599,116.
(63) Continuation-in-part of application No. 10/269,927, filed on Oct. 11, 2002.
(63) Continuation-in-part of application No. 09/502,902, filed on Feb. 11, 2000, now Pat. No. 6,436,320.
(63) Continuation-in-part of application No. 09/503,832, filed on Feb. 15, 2000, now Pat. No. 6,632,079.
(63) Continuation-in-part of application No. 09/618,666, filed on Jul. 18, 2000, now Pat. No. 6,638,049.
(63) Continuation-in-part of application No. 09/656,846, filed on Sep. 7, 2000, now Pat. No. 6,514,440.
(63) Continuation-in-part of application No. 09/841,322, filed on Apr. 24, 2001, now Pat. No. 6,585,505.
(63) Continuation-in-part of application No. 10/101,278, filed on Mar. 19, 2002.
(63) Continuation-in-part of application No. 10/175,995, filed on Jun. 20, 2002.
(63) Continuation-in-part of application No. 10/214,118, filed on Aug. 8, 2002.
(63) Continuation-in-part of application No. 10/328,457, filed on Dec. 23, 2002.
(60) Provisional application No. 60/399,409, filed on Jul. 31, 2002.

(51) Int. Cl. B29C 45/76

(52) U.S. Cl. 425/145; 264/40.1; 264/40.7; 264/328.1; 425/146; 425/149; 425/162; 425/563; 425/564; 700/200; 703/9

(57) ABSTRACT

A system for generating a simulation of fluid flow in an injection molding process carried out by an injection molding machine having an injection unit for injecting the fluid into a manifold delivering the fluid to at least two injection ports leading to one or more cavities of one or more molds. The system comprises one or more programs containing a set of instructions that generate a calculated property, state, position or image of the fluid flowing into or through each cavity, the one or more programs using one or more variable inputs that are representative of one or more selected properties, characteristics or operating parameters of the machine or the fluid. The variable inputs include at least a first value indicative of a first fluid flow rate downstream of the injection unit leading to or through a first injection port and a second value indicative of a second fluid flow rate downstream of the injection unit leading to or through a second injection port.

### RELATED APPLICATIONS

This application claims the benefit of priority under 35 USC Section 120 to and is a continuation-in-part of all of the following: U.S. patent application Ser. No. 09/063,762 filed Apr. 21, 1998; U.S. Ser. No. 10/144,480 filed May 13, 2002, U.S. Ser. No. 10/269,927 filed Oct. 11, 2002, U.S. Ser. No. 09/502,902 filed Jan. 11, 2000, U.S. Ser. No. 09/503,832 filed Feb. 15, 2000, U.S. Ser. No. 09/618,666 filed Jul. 18, 2000, U.S. application Ser. No. 09/656,846 filed Sep. 7, 2000, U.S. application Ser. No. 09/841,322 filed Apr. 24, 2001, U.S. application Ser. No. 10/101,278 filed Mar. 19, 2002, U.S. application Ser. No. 10/175,995 filed Jun. 20, 2002, U.S. application Ser. No. 10/214,118, filed Aug. 8, 2002 and U.S. application Ser. No. 10/328,457 filed Dec. 23, 2002. The disclosures of all of the foregoing applications are incorporated by reference herein in their entirety.

This application also claims priority under 35 USC Section 119 to all of the following: U.S. provisional patent application serial No. 60/399,409 filed Jul. 13, 2002, U.S. provisional application serial No. 60/342,119 filed Dec. 26, 2001 the disclosures of all of the foregoing are incorporated herein by reference in their entirety.

The disclosures of U.S. Pat. No. 5,894,025, U.S. Pat. No. 6,062,840, U.S. Pat. No. 6,294,122, U.S. Pat. No. 6,309,208, U.S. Pat. No. 6,287,107, U.S. Pat. No. 6,343,921, U.S. Pat. No. 6,254,377, U.S. Pat. No. 6,261,075, U.S. Pat. No. 6,361,300, U.S. application Ser. No. 09/699,856 filed Oct. 30, 2000 and U.S. application Ser. No. 10/006,504 filed Dec. 3, 2001 are also incorporated herein by reference in their entirety.

### BACKGROUND OF THE INVENTION

Conventional injection molding systems comprise an injection molding machine having a barrel and an injection unit typically comprising a screw (or ram) housed within a barrel which injects a fluid material from an exit port of the barrel at a preselected velocity or profile of velocities over an injection cycle into a flow channel or system of channels in a distribution manifold which, in turn, direct the fluid to one or more injection ports which lead to one or more cavities of one or more molds.

Programs have been developed for simulating the flow of fluids in an injection molding machine and its associated hotrunner, manifold, nozzle and mold equipment. Such programs are modeled to utilize as a variable input the speed, force or pressure generating capacity of the injection molding machine injection unit (in a format such as volume of an injection shot over time, stroke length versus speed of the ram/screw, time versus speed of the ram/screw, time versus stroke length or the like) as the fundamental basis for generating a simulation of fluid flow and other selected operating parameters of an injection molding apparatus. Programs have also been developed to calculate a preferred set of operating parameters for an injection molding process based on such simulations. A typical input for such programs as with simulation programs is the speed of the injection unit, e.g. ram, plunger or screw, of the injection molding machine. Thus, conventional simulation programs are fundamentally based on a model of the process that employs a single mechanical component or a single location at which the rate of flow of fluid through all flow channels and to all injection ports in the injection cycle is controlled. An example of a commercially available simulation program is a product designated MPI available from Moldflow Corporation, Wayland, Mass. Other programs available from Moldflow Corporation that can use simulation data as a component in a protocol that monitors and/or controls an operating injection molding apparatus are designated MPX, Shotscope and EZTrack.

### SUMMARY OF THE INVENTION

Surface and solid modeling of three dimensional objects is a known process enabled by known computer aided drafting (CAD) technology with programs such as ProEngineer (available from Parametric Technology Corporation), SolidWorks (available from SolidWorks Corporation) and other modeling programs used in computer aided modeling of mechanical devices. Such modeling of the two or three dimensional geometry of the mold cavity, the barrel of the injection molding machine, the fluid flow channels within the hotrunner or manifold, the nozzles and bores of the hotrunner/manifold system of the injection molding apparatus and the valves generally of the system can provide two or three dimensional representations of any one or more of these mechanical components of the apparatus in a readily processable digital electronic data format. Such electronic data is particularly suited for and most preferably used as at least one variable input to a simulation program according to the invention.

The invention provides a method for generating a simulation of an injection molding cycle (for a given 3-dimensional system which has been modeled in advance) in which the rate of fluid flow is independently controllable or variable at one or more local positions in the fluid flow path downstream of the exit point or port of the barrel of the injection molding machine. The local points of independent fluid flow control are typically located within a fluid distribution manifold or other heated component of the system downstream of the exit port of the machine barrel. A hotrunner is a heated manifold having flow channels or bores through which the injection material flows freely at a relatively uniform temperature across a cross section of the channel without significantly cooler (and thus significantly slower flowing) portions of the material occurring along a cross section of the flow stream. A hotrunner may feed into another downstream runner/manifold that is not heated sufficiently to maintain a uniformly heated fluid.

The invention also provides a method, program and system for automatically generating and determining one or more selected operating parameters, part properties/conditions or characteristics.

A set of computer processable instructions for generating a simulation according to the invention uses, as a variable input, data that is indicative of rate of flow of fluid that is flowing at a free fluid flowing position upstream of the injection port of a mold cavity and downstream of the machine barrel exit, e.g. within the bore of a hotrunner channel or heated injection nozzle having a bore communicating with a hotrunner bore or channel. At such heated positions along the downstream fluid flow, the temperature of the fluid material is relatively uniform and does not have substantial sections along a cross section of the flow that are so different in temperature as to result in any significant cooling. The rate of fluid material flow downstream of the machine barrel exit can be controlled at multiple separate positions in an actual injection molding system that is to be simulated according to the invention. These multiple positions may feed a single mold cavity or multiple different mold cavities. The flow rate data used by a program according to the invention can comprise data representative of flow separately occurring at any one or all of the multiple positions downstream of the machine barrel exit that feed one or more separate cavities in the system to be simulated.

Flow rate data as used herein means any data that can be estimated, obtained or recorded that is indicative of fluid flow rate at one, and preferably two or more, positions downstream of the exit of the machine barrel where fluid material is free flowing and relatively uniform in temperature. Apart from velocity data per se which is directly measurable with a flow meter, flow rate data may comprise or be derived from the pressure of the fluid, the time required for filling a selected volume of a mold cavity or flow channel within the injection apparatus or the position of a flow rate controller mechanism such as a valve pin, a rotary valve, a shooting pot plunger or the like. Flow rate data may also comprise the force, energy, pressure, voltage or the like consumed or needed to drive or operate a flow rate controller mechanism at the one or more positions downstream of the machine barrel exit.

Pressure data is measurable in an actual injection apparatus using a pressure transducer. Position of an actuator, valve pin or other mechanical mechanism is measurable with a position sensor. Electrical force, power, energy or voltage used or consumed in driving an actuator for a flow rate controller is measurable with conventional recording devices.

Such data is convertible to any selected format or units that may be required by the simulation program to use the data as a variable indicative of flow rate to generate a simulation. Such data can be converted to variables usable by the program by a subroutine of instructions incorporated into the simulation program itself or by another program executed by the same or a different processor.

Flow rate data occurring at one, and typically at two or more, injection positions downstream of the barrel exit port is input into or accessed by the simulation program in any conventional manner using conventional digital data/computer processing equipment and programming languages.

The flow rate data that is input into the program typically includes: (1) flow rate data for the period of time that occurs between the start of the cavity fill cycle to the time when the cavity is completely filled (i.e. fill time data), (2) flow rate data for a period of time after the cavity is filled when the material in the mold cavity is held under pressure for a selected period of time for purposes of packing the material (i.e. pack time data), (3) flow rate data for the next following period of time from the end of the pack time during which the packed material is typically held under pressure (i.e. hold time data) and (4) flow rate data during the period of time following the end of the hold time period during which the material is cooled for some additional period of time (i.e. cool time data). The actual rate of fluid flow may be very small or zero during the pack time, hold time and cool time periods. Typically during the pack time a relatively small amount of material may flow into the cavity. During the subsequent hold time, little to no additional flow into the mold cavity occurs, the material being held under pressure to reduce or eliminate warpage and/or shrinkage of the material as it is cooling within the mold cavity due to the significantly lower temperature of the mold relative to the hotrunner from which the flow originated. Nonetheless, data indicative of such minimal or zero fluid flow rate into/through the cavity such as material pressure in the hotrunner channels or nozzles can comprise a component of the flow rate data that is input as a variable into the simulation program to generate a simulation of the fluid flow into and through the cavity(ies) over the period of an entire injection cycle.

The flow rate data is preferably initially obtained by the user by estimation from data that has been previously generated (in trials or actual production cycles) using an already existing/old hotrunner and mold cavity system having flow controllers (i.e. injection valves, rotary valves, shooting pot rams and the like), hotrunner channel and mold cavity geometries or volumes that are similar to, or the same as the specific system for which a simulation is to be generated.

Estimated flow rate data can also be calculated from data generated by injection mold systems that are different in size or configuration from the injection mold system to be simulated. For example, beginning with data obtained using an already existing system having flow channel and mold cavity volumes that are different from the new system to be simulated, a user may calculate estimated fill time data for the new system according to a predetermined algorithm. The user may do so by, for example, multiplying the fill time data obtained on the existing/old system by a factor equal to the relative size of the volume of the new and old systems. The pack time data, hold time data and cool time data may be similarly estimated by manipulating the data obtained on the existing/old system according to an algorithm determined by an experienced engineer to most likely produce/calculate the optimum pack, hold and cool time data for the new system.

Flow rate data can be alternatively obtained or determined by trial operation of the actual injection molding system itself and measurement of the flow rate at the selected locations downstream of the machine barrel exit during the trial run(s). In such trial operations a flow rate that produces an optimum quality part and/or an optimum cycle time is recorded/determined separately for each injection port in the system, although trial runs leaving all injection ports operational at the same or at overlapping times may also be employed.

To the extent they can be obtained, predetermined or pre-specified, by measurement, by operating controls or from product specifications, other variables that may be used as inputs to a simulation program according to the invention are:

Shear rate, shear value, melt temperature, freezing point, molecular weight, density and other known or measurable intrinsic properties of the material to be injected which is typically polymer or plastic material;

Temperature of the mold(s), hotrunner(s), manifold(s), barrel, ram/screw, injection nozzle(s) and other components of the injection molding apparatus;

Speed or velocity of ram/screw, or fluid injection velocity by the ram/screw;

Pressure/force exerted on the ram/screw or fluid in the machine barrel.

Thus in accordance with the invention there is provided, a system for generating a simulation of fluid flow in an injection molding process carried out by an injection molding machine having a screw for injecting the fluid into a manifold delivering the fluid to at least two injection ports leading to one or more cavities of one or more molds; the system comprising one or more programs containing a set of instructions that generate a calculated property, state, position or image of the fluid flowing into or through each cavity, the one or more programs using one or more variable inputs that are representative of one or more selected properties, characteristics or operating parameters of the machine or the fluid; the variable inputs comprising at least a first value indicative of a first fluid flow rate downstream of the screw leading to or through a first injection port and a second value indicative of a second fluid flow rate downstream of the screw leading to or through a second injection port.

The invention also provides a method for generating a simulation of fluid flow in an injection molding process carried out by an injection molding machine having a screw for injecting the fluid into a manifold delivering the fluid to at least two injection ports leading to one or more cavities, the method comprising: calculating a property, state, position or image of the fluid flowing into or through each cavity using a program which uses one or more variable inputs that are representative of one or more selected properties, characteristics or operating parameters of the machine or the fluid; inputting to the program variable inputs that comprise at least a first value indicative of a fluid flow rate downstream of the screw leading to or through a first injection port to the one or more cavities and a second value indicative of a fluid flow rate downstream of the screw leading to or through a second injection port to the one or more cavities.

In another aspect of the invention there is provided a system for generating a simulation of fluid flow in an injection molding process carried out by an injection molding machine having a screw for injecting the fluid into a manifold that delivers the fluid to first and second injection ports that are independently controllable to control rate of fluid flow through each port into one or more cavities of one or more molds, the system comprising: a mechanism that generates a calculated property, state, position or image of the fluid flowing into or through the one or more cavities comprising a program that uses one or more variable inputs that are representative of one or more selected properties, characteristics or operating parameters of the machine or the fluid; wherein the program includes a set of instructions for processing as an input a first value indicative of a first rate of fluid flow downstream of the screw leading to or through the first injection port to generate a calculated property, state, position, characteristic or image of the fluid flowing into or through the one or more cavities, and, wherein the program includes a set of instructions for processing as an input a second value indicative of a second rate of fluid flow downstream of the screw leading to or through the second injection port to generate a calculated property, state, position, characteristic or image of the fluid flowing into or through the one or more cavities.

In another aspect of the invention there is provided a method for generating a simulation of fluid flow in an injection molding process carried out by an injection molding machine having a screw for injecting the fluid into a manifold that delivers the fluid to an injection port to a cavity of a mold, the flow to the injection port being independently controllable downstream of the screw to control rate of fluid flow through the injection port, the method comprising: calculating a property, state, position or image of the fluid flowing into or through the cavity using a program which uses one or more variable inputs that are representative of one or more selected properties, characteristics or operating parameters of the machine or the fluid; inputting as a first variable input to the program a first value indicative of a first rate of fluid flow leading to or through the injection port over a period of time during filling of the cavity, and, inputting as a second variable input to the program a second value indicative of a second rate of fluid flow leading to or through the injection port over a period of time following filling of the of the cavity.

The present invention also provides a system for simulating a flow of fluid into or through one or more cavities of one or more molds in an injection molding apparatus, the apparatus having a manifold with channels leading to first and second injection ports to the one or more cavities and a screw for delivering fluid to the manifold, the system comprising: a program that generates a simulation of fluid flow into or through the one or more cavities; the program having a first set of instructions for processing a first data set; the first data set comprising a set of values representative of a first fluid flow rate leading to or through the first injection port during an injection cycle, wherein the first fluid flow rate is selectively controllable downstream of the screw; the program having a second set of instructions for processing a second data set; the second data set comprising a set of values representative of a second fluid flow rate leading to or through the second injection port during the injection cycle, wherein the second fluid flow rate is selectively controllable downstream of the screw.

In another aspect of the invention there is provided a system for simulating a flow of fluid material into or through one or more cavities of one or more molds in an injection molding apparatus, the apparatus having a manifold with channels leading to an injection port to the one or more cavities and a screw for delivering fluid to the manifold, the system comprising: a program that generates a simulation of fluid flow into or through the one or more cavities; the program having a set of instructions for processing first and second data sets to generate the simulation; the first and second data sets comprising a set of values representative of a fluid flow rate leading to or through the injection port at a flow controllable position downstream of the machine barrel; the first data set comprising a set of values indicative of the fluid flow rate over a period of time of a single injection cycle when the one or more cavities are being filled with the fluid material; the second data set comprising a set of values indicative of the fluid flow rate over a period of time following the time when the one or more cavities are being filled with the fluid material.

### BRIEF DESCRIPTION OF THE DRAWINGS

The above and further advantages of the invention may be better understood by referring to the following description in conjunction with the accompanying drawings in which:

FIG. 1 is a partially schematic cross-sectional view of an injection molding system used in one embodiment of the present invention;

FIG. 2 is an enlarged fragmentary cross-sectional view of one side of the injection molding system of FIG. 1;

FIG. 3 is an enlarged fragmentary cross-sectional view of an alternative embodiment of a system similar to FIG. 1, in which a plug is used for easy removal of the valve pin;

FIG. 4 is an enlarged fragmentary cross-sectional view of an alternative embodiment of a system similar to FIG. 1, in which a threaded nozzle is used;

FIG. 5 is a view similar to FIG. 4, showing an alternative embodiment in which a plug is used for easy removal of the valve pin;

FIG. 5a is a generic view of the end of the nozzles shown in FIGS. 1-5;

FIG. 5b is a close-up more detailed view of a portion of the nozzle end encircled by arrows 5b-5b shown in FIG. 5a;

FIG. 5c is cross-sectional view of an alternative nozzle end configuration similar to the FIGS. 5a and 5b configuration;

FIG. 6 shows a fragmentary cross-sectional view of a system similar to FIG. 1, showing an alternative embodiment in which a forward valve pin shut-off is used;

FIG. 7 shows an enlarged fragmentary view of the embodiment of FIG. 6, showing the valve pin in the open and closed positions, respectively;

FIG. 8 is a cross-sectional view of an alternative embodiment of a system used in the present invention similar to FIG. 6, in which a threaded nozzle is used with a plug for easy removal of the valve pin;

FIG. 9 is an enlarged fragmentary view of the embodiment of FIG. 8, in which the valve pin is shown in the open and closed positions;

FIG. 10 is an enlarged view of an alternative embodiment of the valve pin, shown in the closed position;

FIG. 11 is a fragmentary cross sectional view of an alternative embodiment of an injection molding system used in the invention having flow control that includes a valve pin that extends to the gate; and

FIG. 12 is an enlarged fragmentary cross-sectional detail of the flow control area;

FIG. 13 is a fragmentary cross sectional view of another alternative embodiment of an injection molding system having flow control that includes a valve pin that extends to the gate, showing the valve pin in the starting position prior to the beginning of an injection cycle;

FIG. 14 is view of the injection molding system of FIG. 13, showing the valve pin in an intermediate position in which material flow is permitted;

FIG. 15 is a view of the injection molding system of FIG. 13, showing the valve pin in the closed position at the end of an injection cycle; and

FIG. 16 shows a series of graphs representing the actual pressure versus the target pressure measured in four injection nozzles coupled to a manifold as shown in FIG. 13;

FIGS. 17 and 18 are screen icons displayed on interface 114 of FIG. 13 which are used to display, create, edit, and store target profiles;

FIG. 19 is a side cross-sectional view of valve having a curvilinear bulbous protrusion and an extended pin, the bulbous protrusion being in a flow shut-off position;

FIG. 19A is a close-up view of the bulbous protrusion of FIG. 19;

FIG. 20 is a view similar to FIG. 32 showing the bulbous protrusion in a flow controlling position;

FIG. 20A is a close-up view of the bulbous protrusion position of FIG. 20;

FIG. 21 is a view similar to FIG. 19 showing the bulbous protrusion in a downstream position and the distal tip end of the extended pin in a gate flow shut-off position;

FIG. 21A is a close-up view of the bulbous protrusion position of FIG. 21;

FIG. 22 is a side cross-sectional view of valve having a curvilinear bulbous protrusion, the bulbous protrusion being in a flow shut-off position and not having a gate shut off distal pin extension section;

FIG. 23 is a view similar to FIG. 22 showing the bulbous protrusion in a flow controlling position;

FIG. 24 is a side cross-sectional view of valve having a curvilinear bulbous protrusion, where the pin is mounted in an aperture in the hot runner which has a diameter equal to the diameter of the bulbous protrusion such that the pin may be withdrawn from the actuator and the hotrunner without removing the actuator from the housing or the mounting bushing from the hotrunner, and where the bulbous protrusion is in a flow shut-off position;

FIG. 24A is a close-up view of the bulbous protrusion in the flow shut off position of FIG. 24;

FIG. 25 is a view similar to FIG. 24 showing the bulbous protrusion in a downstream flow controlling position;

FIG. 25A is a close-up view of the bulbous protrusion in the flow controlling position of FIG. 25;

FIG. 26 is a schematic side cross-sectional view of an embodiment of a pin having a bulbous protrusion with a maximum diameter circumferential section which has straight surfaces, e.g. cylindrical, which complementarily mate with a complementary straight cylindrical surface on the interior of the flow channel at a throat section;

FIG. 27 is a schematic side cross-sectional view of an embodiment showing a bulbous protrusion similar to FIG. 26 but where the controlling flow position is upstream of the throat section of the channel and the flow shut-off position is achieved or reached by forward or upstream movement of the pin from the position shown in FIG. 27;

FIG. 28 is a demonstrative showing certain types of data that a simulation program according to the invention preferably contains instructions for processing into a calculated simulation of an injection cycle;

FIG. 28A is a schematic representation of fluid injection through three ports to two cavities;

FIG. 28B is a schematic representation of fluid injection through four ports to four cavities;

FIG. 29 is an example of a three dimensional image output by a simulation program according to the invention reporting pressure as the end of a simulated filling cycle;

FIG. 30 is an example a three dimensional image output by a simulation program according to the invention showing the location of air traps in a simulated injection molded part;

FIG. 31 is an example of a three dimensional image output by a simulation program according to the invention showing the fill time as a gradient throughout the volume of a simulated injection molded part;

FIG. 32 is an example of a three dimensional image output by a simulation program according to the invention reporting the temperature at the flow front of a simulated injection molded part;

FIG. 33 is an example of a plot that can be generated by a simulation program according to the invention showing clamp force versus time of a simulated injection cycle;

FIG. 34 is a flow chart showing steps of which a typical program according to the invention can be comprised.

### DETAILED DESCRIPTION

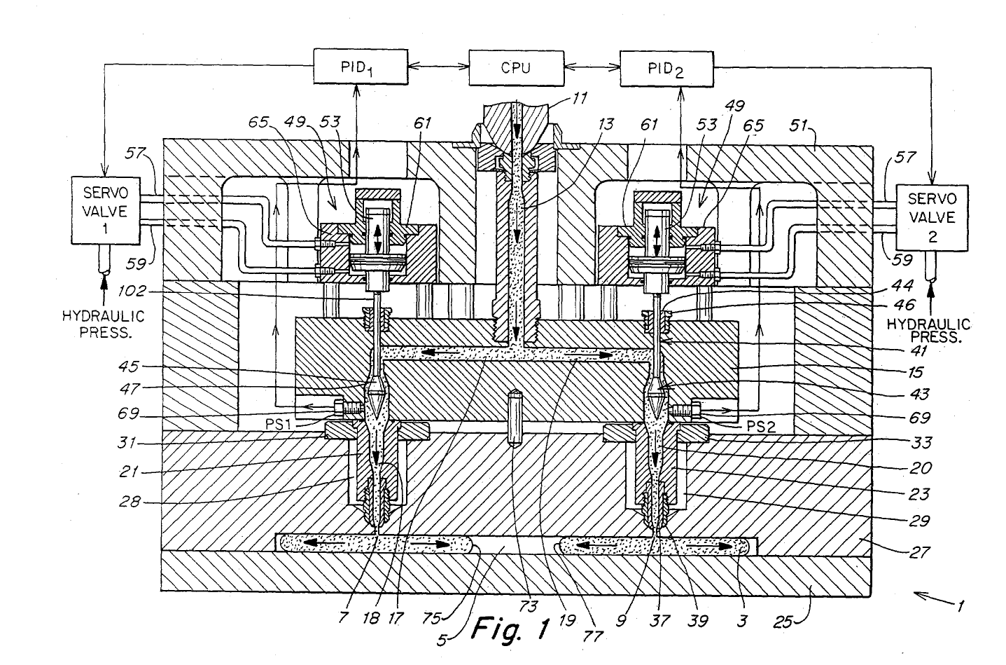

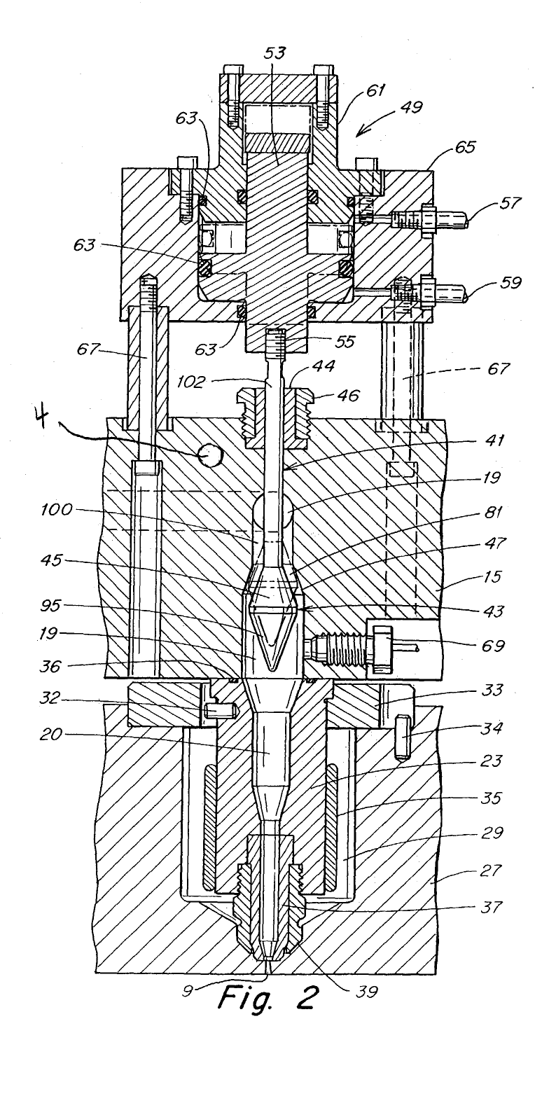

FIGS. 1-2 show one embodiment of an injection molding system according to the present invention having two nozzles 21, 23 the plastic flow through which are to be controlled dynamically according to an algorithm as described below. Although only two nozzles are shown in FIGS. 1-2, the invention contemplates simultaneously controlling the material flow through at least two and also through a plurality of more than two nozzles. In the embodiment shown, the injection molding system 1 is a multi-gate single cavity system in which melt material 3 is injected into a cavity 5 from the two gates 7 and 9. Melt material 3 is injected from an injection molding machine 11 through an extended inlet 13 and into a manifold 15. Manifold 15 distributes the melt through channels 17 and 19. Although a hot runner system is shown in which plastic melt is injected, the invention is applicable to other types of injection systems in which it is useful to control the rate at which a material (e.g., metallic or composite materials) is delivered to a cavity.

Melt is distributed by the manifold through channels 17 and 19 and into bores 18 and 20 of the two nozzles 21 and 23, respectively. Melt is injected out of nozzles 21 and 23 and into cavity 5 (where the part is formed) which is formed by mold plates 25 and 27. Although multi-gate single-cavity system is shown, the invention is not limited to this type of system, and is also applicable to, for example, multi-cavity systems, as discussed in greater detail below.

The injection nozzles 21 and 23 are received in respective wells 28 and 29 formed in the mold plate 27. The nozzles 21 and 23 are each seated in support rings 31 and 33. The support rings serve to align the nozzles with the gates 7 and 9 and insulate the nozzles from the mold. The manifold 15 sits atop the rear end of the nozzles and maintains sealing contact with the nozzles via compression forces exerted on the assembly by clamps (not shown) of the injection molding machine. An O-ring 36 is provided to prevent melt leakage between the nozzles and the manifold. A dowel 73 centers the manifold on the mold plate 27. Dowels 32 and 34 prevent the nozzle 23 and support ring 33, respectively, from rotating with respect to the mold 27.

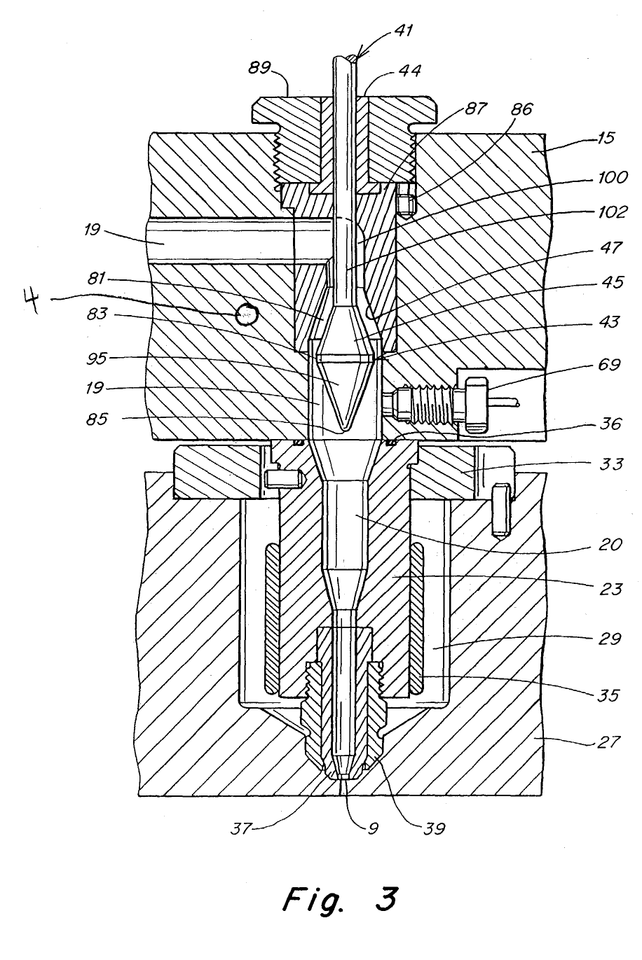

In the embodiment shown in FIGS. 1-3 an electric band heater 35 for heating the nozzles is shown. In other embodiments, heat pipes, such as those disclosed in U.S. Pat. No. 4,389,002, the disclosure of which is incorporated herein by reference and discussed below, may be disposed in a nozzle and used alone or in conjunction with a band heater 35. The heater is used to maintain the melt material at its processing temperature as far up to the point of exit through/into gates 7 and 9 as possible. As shown, the manifold is heated to elevated temperatures sufficient to maintain the plastic or other fluid which is injected into the manifold distribution ducts 17, 19 at a preferred preselected flow and processing temperature. A plurality of heat pipes 4 (only one of which is shown in FIGS. 2, 3) are preferably disposed throughout the manifold/hotrunner 15 so as to more uniformly heat and maintain the manifold at the desired processing temperature.

The mold plate or body 27 is, on the other hand, typically cooled to a preselected temperature and maintained at such cooled temperature relative to the temperature of the manifold 15 via cooling ducts 2 through which water or some other selected fluid is pumped during the injection molding process in order to effect the most efficient formation of the part within the mold cavity.

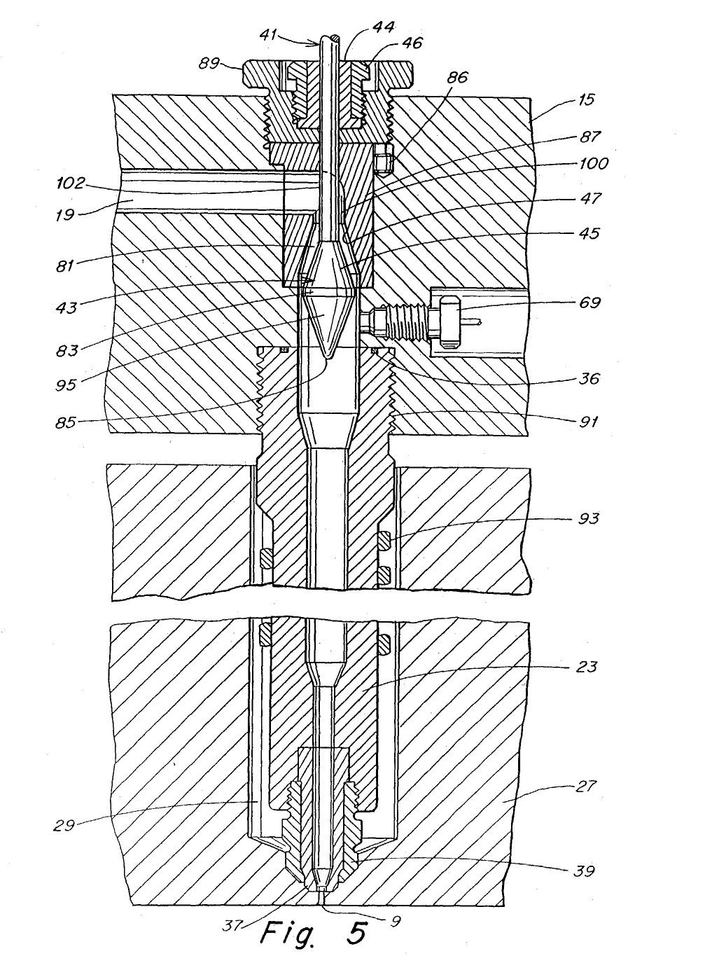

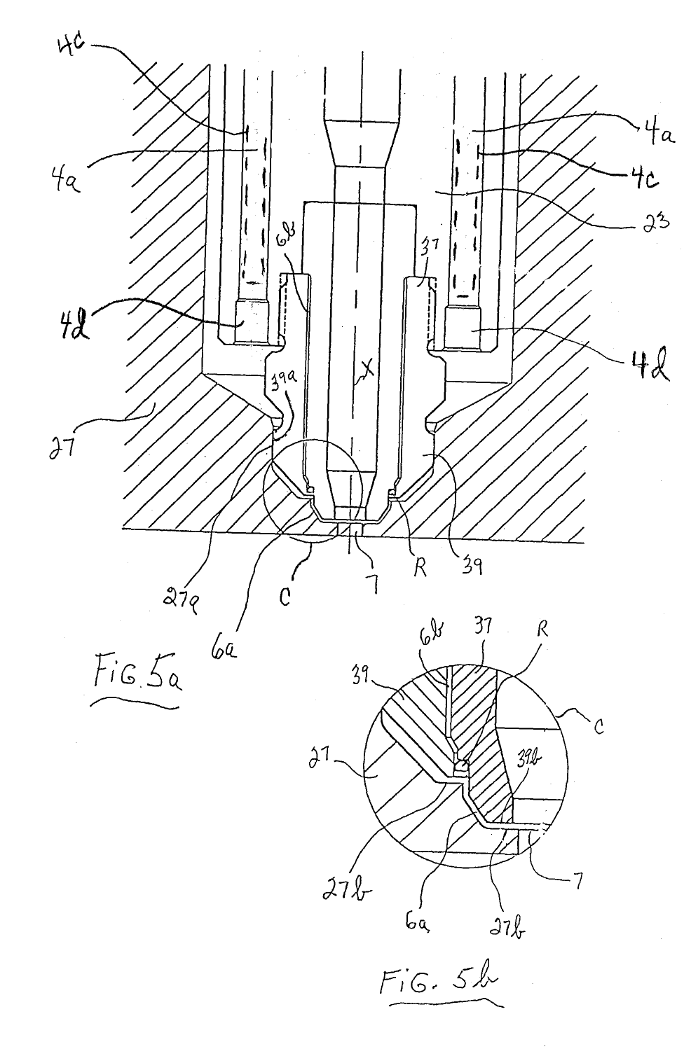

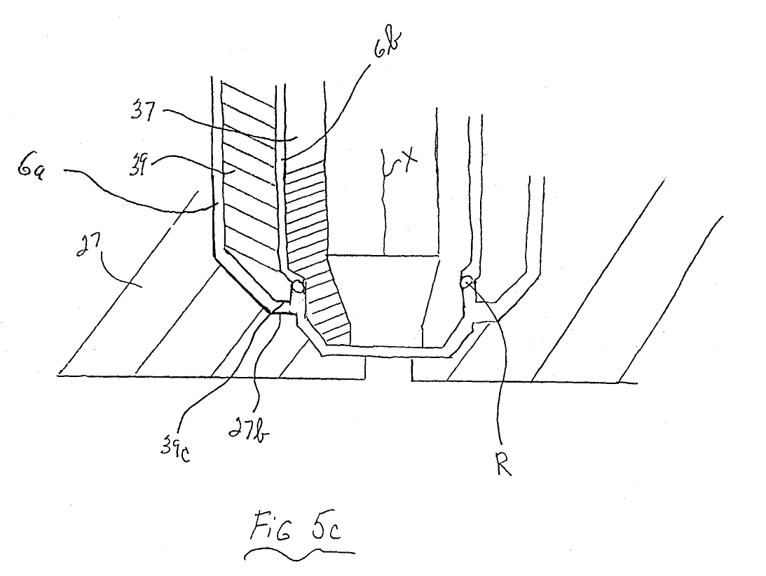

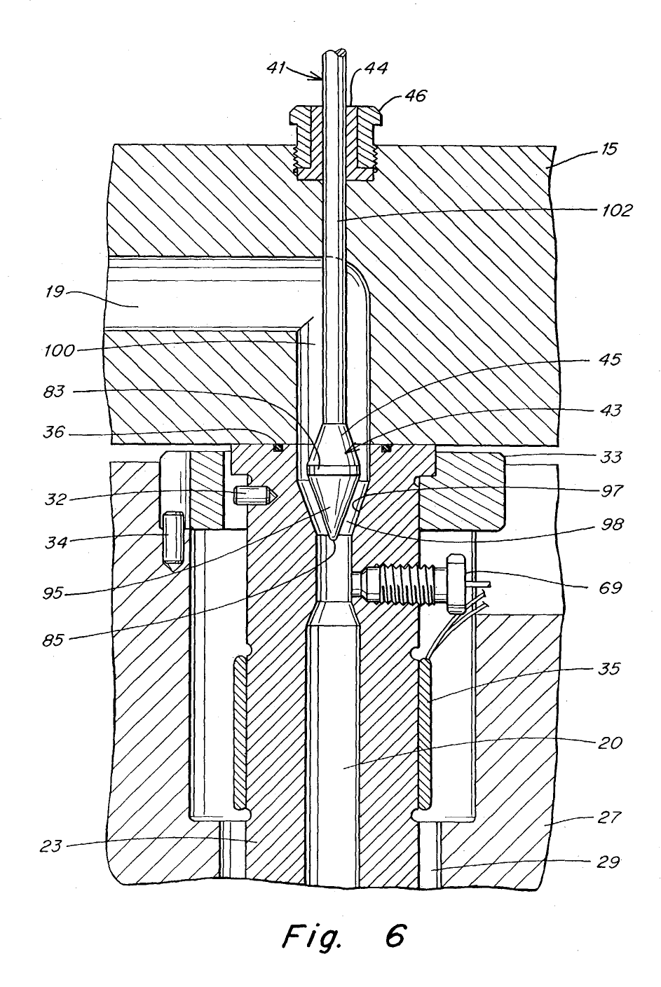

As shown in FIGS. 1-5b, the injection nozzle(s) is/are mounted within well 29 so as to be held in firmly stationary alignment with the gate(s) 7, 9 which lead into the mold cavities. The mounting of the heated nozzle(s) is/are arranged so as to minimize contact of the nozzle(s) body and its associated components with the cooled mold plate 27 but at the same time form a seal against fluid leakage back into an insulative air space in which the nozzle is disposed thus maintaining the fluid pressure within the flow bore or channel against loss of pressure due to leakage. FIGS. 5a, 5b show a more detailed schematic view of the nozzle mountings of FIGS. 1-5. As shown, there is preferably provided a small, laterally disposed, localized area 39a at the end of the nozzle for making compressed contact with a complementary surface 27a of the plate 27. This area of compressed contact acts both as a mount for maintaining the nozzle in a stationary, aligned and spaced apart from the plate 27 relationship and also as a seal against leakage of fluid back from the gate area into the insulative space 29 in well left between the nozzle and the mold plate 27. In the embodiment shown the mating area of the nozzle 39a is a laterally facing surface although a longitudinally facing surface may also be selected for effecting such a seal. The dimensions of the inner and outer pieces are machined so that compression mating between the laterally facing nozzle surface 39a and plate surface 27a occurs upon heating of the nozzle to its operating temperature which expands both laterally and longitudinally upon heating. The lateral mating surfaces 27a and 39a typically enables more ready machining of the parts, although compression mating between axially or longitudinally facing surfaces such as 39b and 27b can be provided for in the alternative. As shown in FIGS. 5a, 5b an insulative space 6a is also left between the most distal tip end surfaces of the nozzle and the mold such that as little direct contact as possible between the heated nozzle and the relatively cooler plate 27 is made.

Another example of lateral or longitudinal surface mating upon heating of the nozzle to operating process temperature is shown and described in U.S. Pat. No. 6,261,084, the disclosure of which is incorporated herein by reference in its entirety.

In an alternative embodiment shown in FIG. 5c, the nozzles may be machined or configured so as to leave a predetermined gap between or a non-compressed mating between two axially or longitudinally facing surfaces 27b and 39c (in the initially assembled cold state) which gap will close upon heating the apparatus up to its operating plastic processing temperature such that the two surfaces 27b and 39c mate under compression to form a seal. As shown in FIG. 5c the insulative air gap 6a is maintained along the lateral edges of the outer piece 39 of the nozzle into which plastic melt does not flow by virtue of a seal which is formed between the surfaces 27b and 39c upon heating of the apparatus up. The same sort of longitudinal/axial seal may be formed using another alternative nozzle embodiment such as disclosed in U.S. Pat. No. 5,885,628, the disclosure of which is incorporated herein by reference, where the outer nozzle piece forms a flange like member around the center portion of the nozzle. In any case, a relatively small surface on the outside of the distal tip end of the nozzles makes compression contact with a surface of the mold plate by virtue of thermally induced expansion of the nozzles such that a seal against melt flow is formed.

The nozzles may comprise a single unitary piece or, as shown in the embodiments in FIGS. 1-5b, the nozzles 21 and 23 may comprise two (or more) separate unitary pieces such as insert 37 and tip 39. The insert 37 is typically made of a material (for example beryllium copper) having a relatively high thermal conductivity in order to maintain the melt at its most preferred high processing temperature as far up to the gate as possible by imparting heat to the melt from the heater 35 and/or via heat pipes as discussed below. In the embodiments shown, the outer tip piece 39 is used to form the seal with the mold plate 27 and preferably comprises a material (for example titanium alloy or stainless steel) having a substantially lower thermal conductivity relative to the material comprising the inner piece 37 so as reduce/minimize heat transfer from the nozzle (and manifold) to the mold as much as possible.

A seal or ring R, FIGS. 5a-5c, is provided in the embodiment shown between the inner 37 and outer 39 pieces. As described in U.S. Pat. Nos. 5,554,395 and 5,885,628, the disclosures of which are incorporated herein by reference, seal/ring R serves to insulate the two nozzle pieces 37, 39 from each other minimizing heat transfer between the two pieces and also by providing an insulative air gap 6b between the two nozzle pieces. The seal R comprises a member made of a metallic alloy or like material which may be substantially less heat conductive than the material of which pieces 37, 39 are comprised. The sealing member R is preferably a thin-walled, substantially resilient structure, and may be adapted for engagement by the seal mounting means so as to be carried by the nozzle piece 39. The sealing member R extends a preselected distance outwardly from the tip portion of the bushing so as to form a sealing engagement along a limited contact area located on the adjoining bore in the mold when the nozzle is operatively disposed therein. More particularly, in one preferred embodiment, it is contemplated that the sealing member R will include at least one portion having a partially open, generally C-shaped or arc-shaped transverse cross-section. Accordingly, the sealing member R may be formed as an O-ring, or as an O-ring defining spaced, aligned openings in its surface. Similarly, the sealing member may be formed as an O-ring having an annular portion removed from its inner wall so as to form a C-shaped or arc-shaped cross-sectional structure. Further, the sealing member may have a generally V-shaped or U-shaped or other cross-section which is dimensionally compatible with the mating areas with nozzle pieces 37, 39, if desired. In addition, the sealing member may be formed as a flexible length of hollow tubing or a flexible length of material having the desired generally C-shaped or arc-shaped or V-shaped or U-shaped transverse cross-section. Other possible configurations also will occur to those skilled in the art in view of the following detailed description of the present invention.

As shown in FIG. 5a, the nozzles may include one or more heat pipes 4a embedded within the body of the nozzles for purposes of more efficiently and uniformly maintaining the nozzle at an elevated temperature. In the FIG. 5a embodiment the heat pipes 4a are disposed in the nozzle body part 23 which typically comprises a high strength tool steel which has a predetermined high heat conductivity and strength. The heat pipes 4 mounted in the manifold, FIGS. 2,3 and heat pipes 4a, FIG. 5a, preferably comprise sealed tubes comprised of copper or steel within which any vaporizable and condensable liquid such as water is enclosed. Mercury may be used as the vaporizable heat transferring medium in the heat pipes 4, 4a, however, it is more preferable to use an inert liquid material such as water. One drawback to the use of water is that there can be a tendency for a reaction to occur between the iron in the steel and the water whereby the iron combines with the oxygen of the water leaving a residue of hydrogen which is an incondensable gas under the conditions of operation of the heat pipe. The presence of hydrogen in the heat pipe is deleterious to its effective operation. For the purposes of this invention any material, such as iron or an alloy of iron, which tends to release hydrogen from water is referred to as “water incompatible material.”

The use of high strength steel is made practicable by plating or otherwise covering the interior wall of each heat pipe with a material which is non-reactive with water. Examples of such materials are nickel, copper, and alloys of nickel and copper, such as monel. Such materials are referred to herein as “water compatible materials.” The inner wall of each heat pipe 4, 4a is preferably plated with a water compatible material, preferably nickel. Such plating is preferably made thick enough to be impermeable to water and water vapor. A wick structure 4c is inserted into each heat pipe, the wick typically comprising a water compatible cylindrical metal screen which is forced into and tightly pressed against the interior wall of a heat pipe. The wick preferably comprises a water compatible material such as monel. The elevated temperature at which the manifold and/or nozzles are maintained during an injection cycle typically ranges between about 200 and about 400 degrees centigrade. The vapor pressure of water at these temperatures, although quite high, is readily and safely contained with the enclosed tubular heat pipes. In practice, less than the total volume of the enclosed heat pipes is filled with the selected fluid, typically less than about 70% of such volume, and more typically less than 50%. Following the insertion of the water, the outer end of each heat pipe is sealed by conventional means. In a preferred embodiment the tubular heat pipes are sealed at one end via a plug 4d as described in U.S. Pat. No. 4,389,002, the disclosure of which is incorporated herein by reference. In operation, the fluid contained within the heat pipes 4, 4a is vaporized by heat conduction from the manifold. The fluid vaporizes and travels to each portion of the heat pipe from which heat is being extracted and the vapor condenses at each such portion to yield up its heat of condensation to maintain the entire length of the heat pipe at the same temperature. The vaporization of water from the inner end of the wick structure 4c creates a capillary attraction to draw condensed water from the rest of the wick structure back to the evaporator portion of the wick thus completing the cycle of water flow to maintain the heat pipe action. Where a plurality of heat pipes are disposed around the nozzle, there is maintained a uniform temperature around the axis X of the nozzle bores, particularly in embodiments where the heat pipes are disposed longitudinally as close to the exit end of the nozzle as possible.

In one embodiment, FIGS. 1-5, a valve pin 41 having a tapered head 43 controllably engagable with a surface upstream of the exit end of the nozzle may be used to control the rate of flow of the melt material to and through the respective gates 7 and 9. The valve pin reciprocates through the flow channel 100 in the manifold 15. A valve pin bushing 44 is provided to prevent melt from leaking along stem 102 of the valve pin. The valve pin bushing is held in place by a threadably mounted cap 46. The valve pin is opened at the beginning of the injection cycle and closed at the end of the cycle. During the cycle, the valve pin can assume intermediate positions between the fully open and closed positions, in order to decrease or increase the rate of flow of the melt. The head includes a tapered portion 45 that forms a gap 81 with a surface 47 of the bore 19 of the manifold. Increasing or decreasing the size of the gap by displacing the valve pin correspondingly increases or decreases the flow of melt material to the gate. When the valve pin is closed the tapered portion 45 of the valve pin head contacts and seals with the surface 47 of the bore of the manifold.

FIG. 2 shows the head of the valve pin in a Phantom dashed line in the closed position and a solid line in the fully opened position in which the melt is permitted to flow at a maximum rate. To reduce the flow of melt, the pin is retracted away from the gate by an actuator 49, to thereby decrease the width of the gap 81 between the valve pin and the bore 19 of the manifold.

The actuator 49 (for example, the type disclosed in application Ser. No. 08/874,962, the disclosure of which is incorporated herein by reference) is mounted in a clamp plate 51 which covers the injection molding system 1. In the embodiment shown, the actuator 49 is a hydraulic actuator, however, pneumatic or electronic actuators can also be used. Other actuator configurations having ready detachability may also be employed such as those described in U.S. Pat. No. 5,948,448 and PCT application US99/11391, the disclosures of both of which are incorporated herein by reference. An electronic or electrically powered actuator may also be employed such as disclosed in U.S. Pat. No. 6,294,122, the disclosure of which is incorporated herein by reference. In the embodiment shown, the actuator 49 includes a hydraulic circuit that includes a movable piston 53 in which the valve pin 41 is threadably mounted at 55. Thus, as the piston 53 moves, the valve pin 41 moves with it. The actuator 49 includes hydraulic lines 57 and 59 which are controlled by servo valves 1 and 2. Hydraulic line 57 is energized to move the valve pin 41 toward the gate to the open position, and hydraulic line 59 is energized to retract the valve pin away from the gate toward the close position. An actuator cap 61 limits longitudinal movement in the vertical direction of the piston 53. O-rings 63 provide respective seals to prevent hydraulic fluid from leaking out of the actuator. The actuator body 65 is mounted to the manifold via screws 67.

In embodiments where a pneumatically or electrically powered actuator is employed, suitable pneumatic (air supply) or electrical power inputs to the actuator are provided, such inputs being controllable to precisely control the movement of the actuator via the same computer generated signals which are output from the PID1 and PID2 controllers and the same or similar control algorithm/program used in the CPU of FIG. 1 such that precise control of the movement of the valve pin used to control plastic flow is achieved according to the predetermined algorithm selected for the particular application.

In the embodiment shown, a pressure transducer 69 is used to sense the pressure in the manifold bore 19 downstream of the valve pin head 43. In operation, the conditions sensed by the pressure transducer 69 associated with each nozzle are fed back to a control system that includes controllers PID 1 and PID 2 and a CPU shown schematically in FIG. 1. The CPU executes a PID (proportional, integral, derivative) algorithm which compares the sensed pressure (at a given time) from the pressure transducer to a programmed target pressure (for the given time). The CPU instructs the PID controller to adjust the valve pin using the actuator 49 in order to mirror the target pressure for that given time. In this way a programmed target pressure profile for an injection cycle for a particular part for each gate 7 and 9 can be followed.

As to each separate nozzle, the target pressure or pressure profile may be different, particularly where the nozzles are injecting into separate cavities, and thus separate algorithms or programs for achieving the target pressures at each nozzle may be employed. As can be readily imagined, a single computer or CPU may be used to execute multiple programs/algorithms for each nozzle or separate computers may be utilized. The embodiment shown in FIG. 1 is shown for purposes of ease of explanation.

Although in the disclosed embodiment the sensed condition is pressure, other sensed conditions can be used which relate to melt flow rate. For example, the position of the valve pin or the load on the valve pin could be the sensed condition. If so, a position sensor or load sensor, respectively, could be used to feed back the sensed condition to the PID controller. In the same manner as explained above, the CPU would use a PID algorithm to compare the sensed condition to a programmed target position profile or load profile for the particular gate to the mold cavity, and adjust the valve pin accordingly. Similarly the location of the sensor and the sensed condition may be other than in the nozzle itself. The location of the measurement may, for example, be somewhere in the cavity of the mold or upstream of the nozzle somewhere in the manifold flow channel or even further upstream in the melt flow.

Melt flow rate is directly related to the pressure sensed in bore 19. Thus, using the controllers PID 1 and PID 2, the rate at which the melt flows into the gates 7 and 9 can be adjusted during a given injection molding cycle, according to the desired pressure profile. The pressure (and rate of melt flow) is decreased by retracting the valve pin and decreasing the width of the gap 81 between the valve pin and the manifold bore, while the pressure (and rate of melt flow) is increased by displacing the valve pin toward the gate 9, and increasing the width of the gap 81. The PID controllers adjust the position of the actuator piston 53 by sending instructions to servo valves 1 and 2.

By controlling the pressure in a single cavity system (as shown in FIG. 1) it is possible to adjust the location and shape of the weld line formed when melt flow 75 from gate 7 meets melt flow 77 from gate 9 as disclosed in U.S. Pat. No. 5,556,582. However, the invention also is useful in a multi-cavity system. In a multi-cavity system the invention can be used to balance fill rates and packing, holding and cooling profiles in the respective cavities. This is useful, for example, when molding a plurality of like parts in different cavities. In such a system, to achieve a uniformity in the parts, the fill rates and packing, holding and cooling profiles of the cavities should be as close to identical as possible. Using the same programmed pressure profile for each nozzle, unpredictable fill rate variations from cavity to cavity are overcome, and consistently uniform parts are produced from each cavity.

Another advantage of the present invention is seen in a multi-cavity system in which the nozzles are injecting into cavities which form different sized parts that require different fill rates and packing, holding and cooling profiles. In this case, different pressure profiles can be programmed for each respective controller of each respective cavity. Still another advantage is when the size of the cavity is constantly changing, i.e., when making different size parts by changing a mold insert in which the part is formed. Rather than change the hardware (e.g., the nozzle) involved in order to change the fill rate and packing, holding and cooling profiles for the new part, a new program is chosen by the user corresponding to the new part to be formed.

The embodiment of FIGS. 1 and 2 has the advantage of controlling the rate of melt flow away from the gate inside manifold 15 rather than at the gates 7 and 9. Controlling the melt flow away from the gate enables the pressure transducer to be located away from the gate (in FIGS. 1-5). In this way, the pressure transducer does not have to be placed inside the mold cavity, and is not susceptible to pressure spikes which can occur when the pressure transducer is located in the mold cavity or near the gate. Pressure spikes in the mold cavity result from the valve pin being closed at the gate. This pressure spike could cause an unintended response from the control system, for example, an opening of the valve pin to reduce the pressure—when the valve pin should be closed.

Avoidance of the effects of a pressure spike resulting from closing the gate to the mold makes the control system behave more accurately and predictably. Controlling flow away from the gate enables accurate control using only a single sensed condition (e.g., pressure) as a variable. The '582 patent disclosed the use of two sensed conditions (valve position and pressure) to compensate for an unintended response from the pressure spike. Sensing two conditions resulted in a more complex control algorithm (which used two variables) and more complicated hardware (pressure and position sensors).

Another advantage of controlling the melt flow away from the gate is the use of a larger valve pin head 43 than would be used if the valve pin closed at the gate. A larger valve pin head can be used because it is disposed in the manifold in which the melt flow bore 19 can be made larger to accommodate the larger valve pin head. It is generally undesirable to accommodate a large size valve pin head in the gate area within the end of the nozzle 23, tip 39 and insert 37. This is because the increased size of the nozzle, tip and insert in the gate area could interfere with the construction of the mold, for example, the placement of water lines within the mold which are preferably located close to the gate. Thus, a larger valve pin head can be accommodated away from the gate.

The use of a larger valve pin head enables the use of a larger surface 45 on the valve pin head and a larger surface 47 on the bore to form the control gap 81. The more “control” surface (45 and 47) and the longer the “control” gap (81)—the more precise control of the melt flow rate and pressure can be obtained because the rate of change of melt flow per movement of the valve pin is less. In FIGS. 1-3 the size of the gap and the rate of melt flow is adjusted by adjusting the width of the gap, however, adjusting the size of the gap and the rate of material flow can also be accomplished by changing the length of the gap, i.e., the longer the gap the more flow is restricted. Thus, changing the size of the gap and controlling the rate of material flow can be accomplished by changing the length or width of the gap.

The valve pin head includes a middle section 83 and a forward cone shaped section 95 which tapers from the middle section to a point 85. This shape assists in facilitating uniform melt flow when the melt flows past the control gap 81. The shape of the valve pin also helps eliminates dead spots in the melt flow downstream of the gap 81.

FIG. 3 shows another aspect in which a plug 87 is inserted in the manifold 15 and held in place by a cap 89. A dowel 86 keeps the plug from rotating in the recess of the manifold that the plug is mounted. The plug enables easy removal of the valve pin 41 without disassembling the manifold, nozzles and mold. When the plug is removed from the manifold, the valve pin can be pulled out of the manifold where the plug was seated since the diameter of the recess in the manifold that the plug was in is greater than the diameter of the valve pin head at its widest point. Thus, the valve pin can be easily replaced without significant downtime.

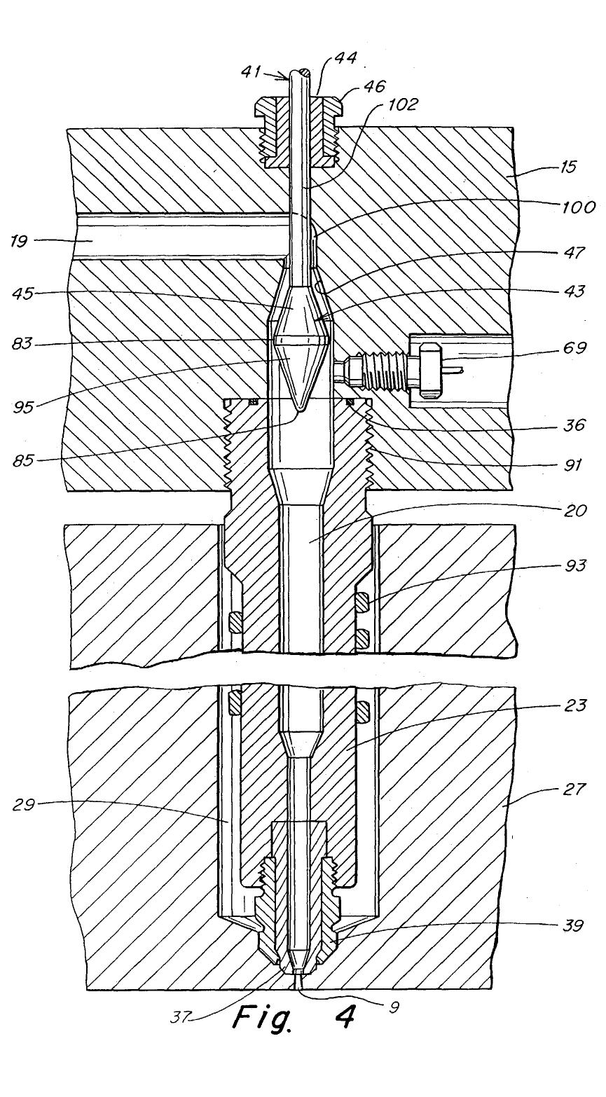

FIGS. 4 and 5 show additional alternative embodiments of the invention in which a threaded nozzle style is used instead of a support ring nozzle style. In the threaded nozzle style, the nozzle 23 is threaded directly into manifold 15 via threads 91. Also, a coil heater 93 is used instead of the band heater shown in FIGS. 1-3. The threaded nozzle style is advantageous in that it permits removal of the manifold and nozzles (21 and 23) as a unitary element. There is also less of a possibility of melt leakage where the nozzle is threaded on the manifold. The support ring style (FIGS. 1-3) is advantageous in that one does not need to wait for the manifold to cool in order to separate the manifold from the nozzles. FIG. 5 also shows the use of the plug 87 for convenient removal of valve pin 41.

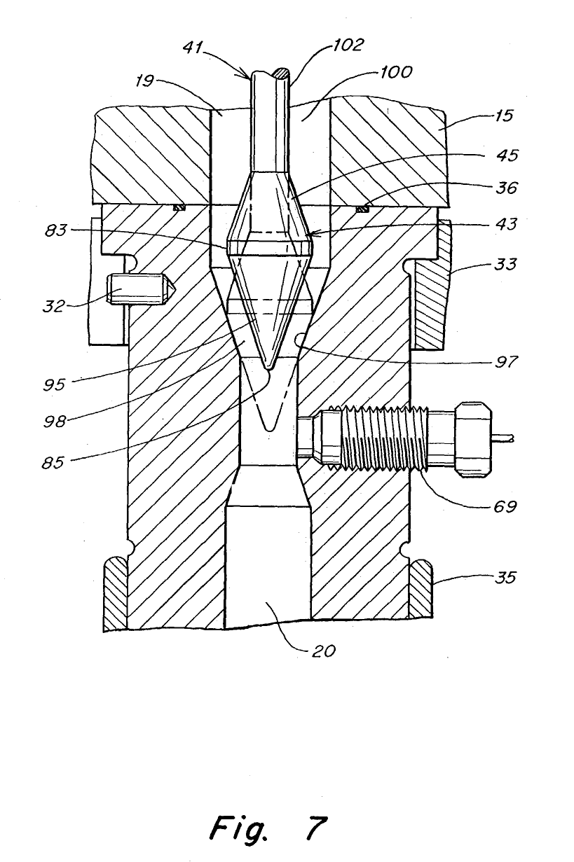

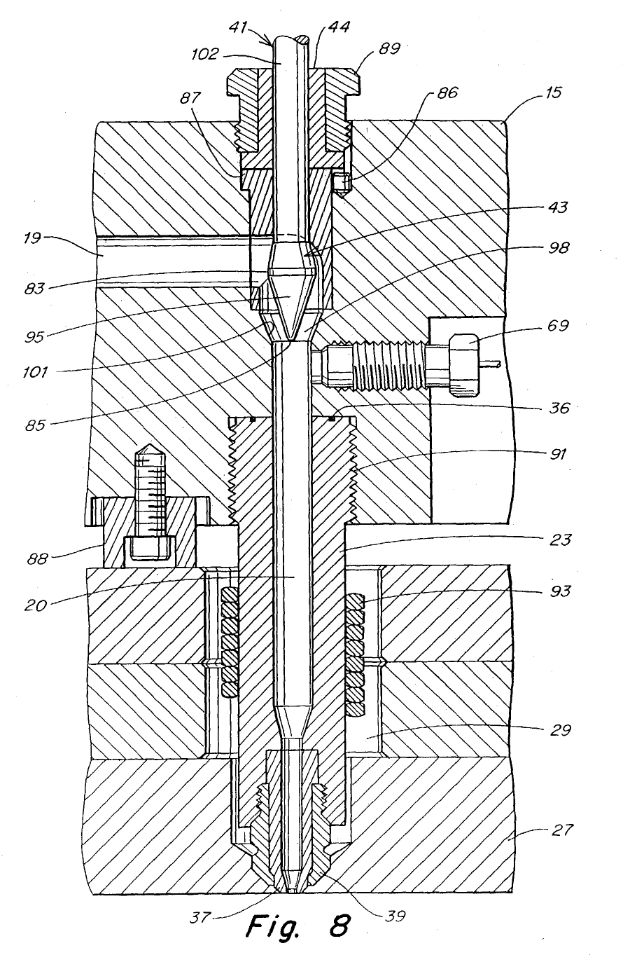

FIGS. 6-10 show an alternative embodiment of the invention in which a “forward” shutoff is used rather than a retracted shutoff as shown in FIGS. 1-5. In the embodiment of FIGS. 6 and 7, the forward cone-shaped tapered portion 95 of the valve pin head 43 is used to control the flow of melt with surface 97 of the inner bore 20 of nozzle 23. An advantage of this arrangement is that the valve pin stem 102 does not restrict the flow of melt as in FIGS. 1-5. As seen in FIGS. 1-5, the clearance 81 between the stem 102 and the bore 19 of the manifold is not as great as the clearance 98 in FIGS. 6 and 7. The increased clearance 98 in FIGS. 6-7 results in a lesser pressure drop and less shear on the plastic.

In FIGS. 6 and 7 the control gap 98 is formed by the front cone-shaped portion 95 and the surface 97 of the bore 20 of the rear end of the nozzle 23. The pressure transducer 69 is located downstream of the control gap—thus, in FIGS. 6 and 7, the nozzle is machined to accommodate the pressure transducer as opposed to the pressure transducer being mounted in the manifold as in FIGS. 1-5.

FIG. 7 shows the valve pin in solid lines in the open position and Phantom dashed lines in the closed position. To restrict the melt flow and thereby reduce the melt pressure, the valve pin is moved forward from the open position towards surface 97 of the bore 20 of the nozzle which reduces the width of the control gap 98. To increase the flow of melt the valve pin is retracted to increase the size of the gap 98.

The rear 45 of the valve pin head 43 remains tapered at an angle from the stem 102 of the valve pin 41. Although the surface 45 performs no sealing function in this embodiment, it is still tapered from the stem to facilitate even melt flow and reduce dead spots.

As in FIGS. 1-5, pressure readings are fed back to the control system (CPU and PID controller), which can accordingly adjust the position of the valve pin 41 to follow a target pressure profile. The forward shut-off arrangement shown in FIGS. 6 and 7 also has the advantages of the embodiment shown in FIGS. 1-5 in that a large valve pin head 43 is used to create a long control gap 98 and a large control surface 97. As stated above, a longer control gap and greater control surface provides more precise control of the pressure and melt flow rate.

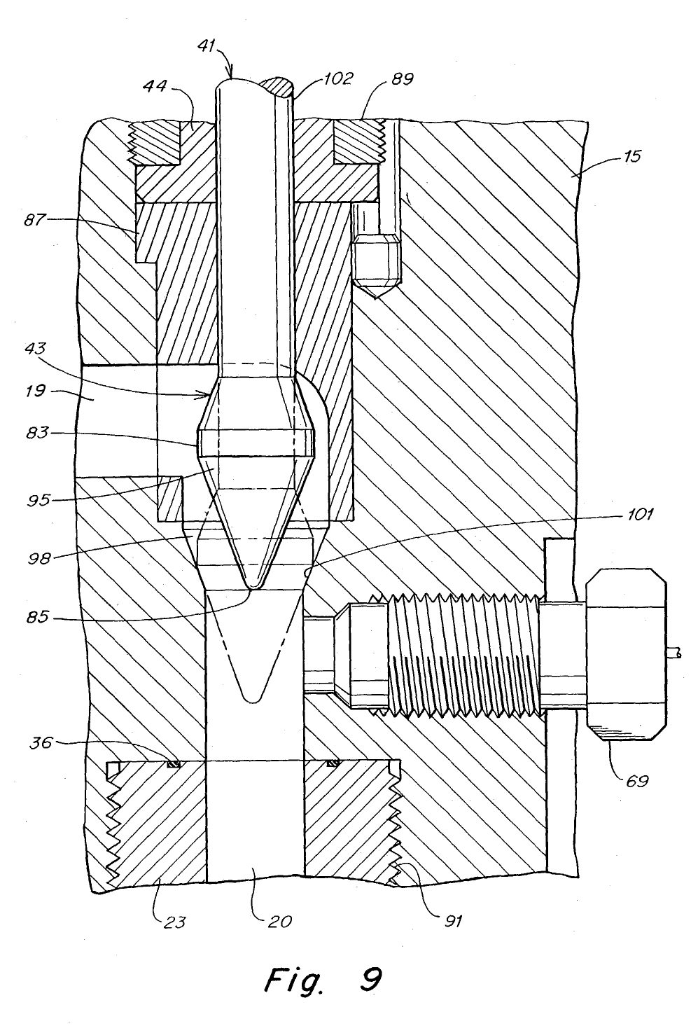

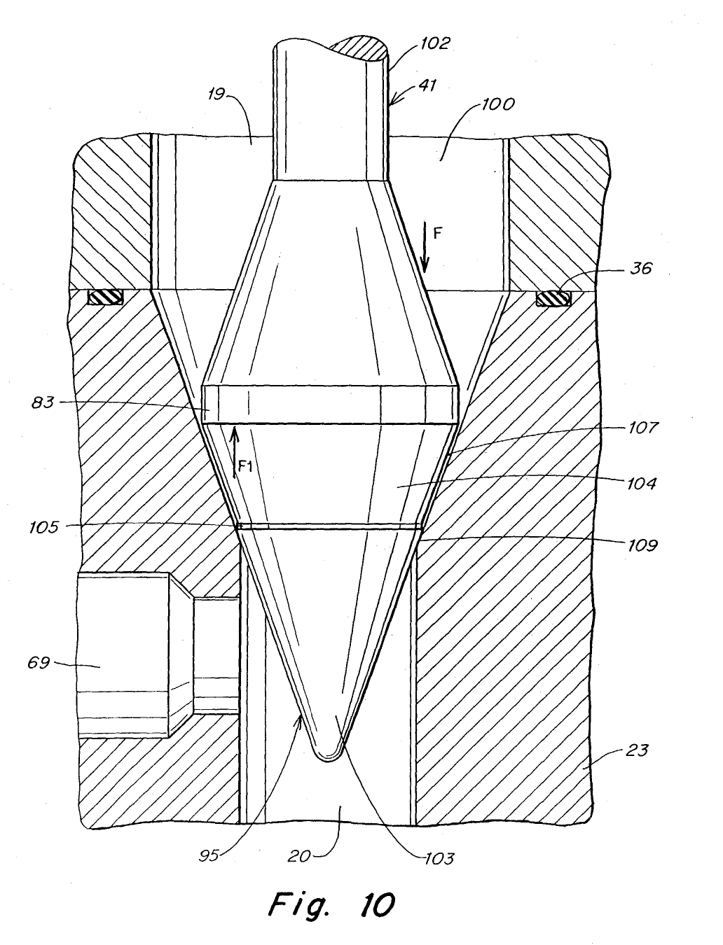

FIGS. 8 and 9 show a forward shutoff arrangement similar to FIGS. 6 and 7, but instead of shutting off at the rear of the nozzle 23, the shut-off is located in the manifold at surface 101. Thus, in the embodiment shown in FIGS. 8 and 9, a conventional threaded nozzle 23 may be used with a manifold 15, since the manifold is machined to accommodate the pressure transducer 69 as in FIGS. 1-5. A spacer 88 is provided to insulate the manifold from the mold. This embodiment also includes a plug 87 for easy removal of the valve pin head 43.

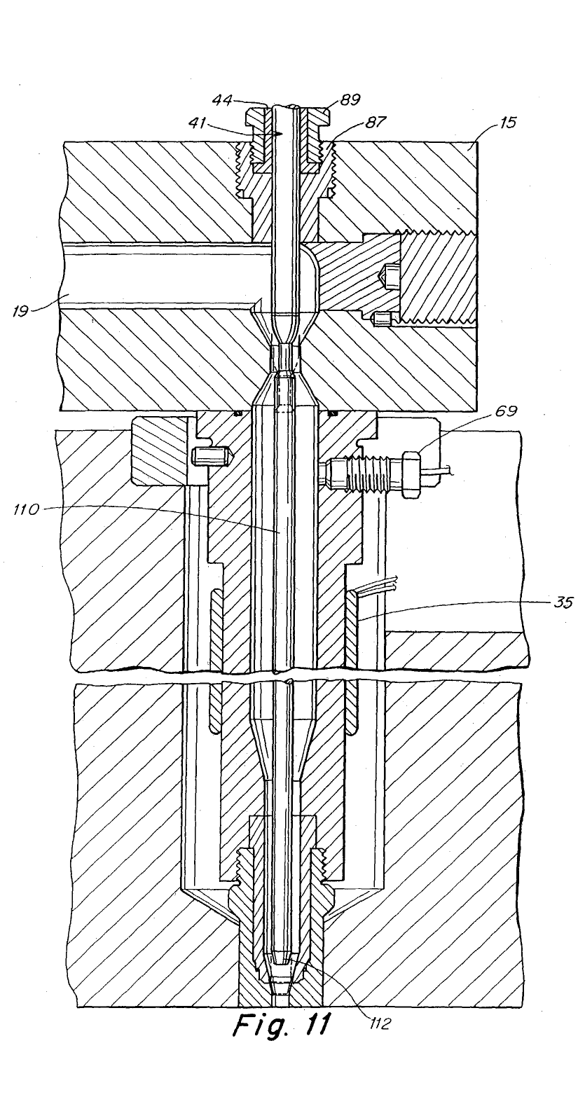

FIG. 10 shows an alternative embodiment of the invention in which a forward shutoff valve pin head is shown as used in FIGS. 6-9. However, in this embodiment, the forward cone-shaped taper 95 on the valve pin includes a raised section 103 and a recessed section 104. Ridge 105 shows where the raised portion begins and the recessed section ends. Thus, a gap 107 remains between the bore 20 of the nozzle through which the melt flows and the surface of the valve pin head when the valve pin is in the closed position. Thus, a much smaller surface 109 is used to seal and close the valve pin. The gap 107 has the advantage in that it assists opening of the valve pin which is subjected to a substantial force F from the melt when the injection machine begins an injection cycle. When injection begins melt will flow into gap 107 and provide a force component F1 that assists the actuator in retracting and opening the valve pin. Thus, a smaller actuator, or the same actuator with less hydraulic pressure applied, can be used because it does not need to generate as much force in retracting the valve pin. Further, the stress forces on the head of the valve pin are reduced.

Despite the fact that the gap 107 performs no sealing function, its width is small enough to act as a control gap when the valve pin is open and correspondingly adjust the melt flow pressure with precision as in the embodiments of FIGS. 1-9.

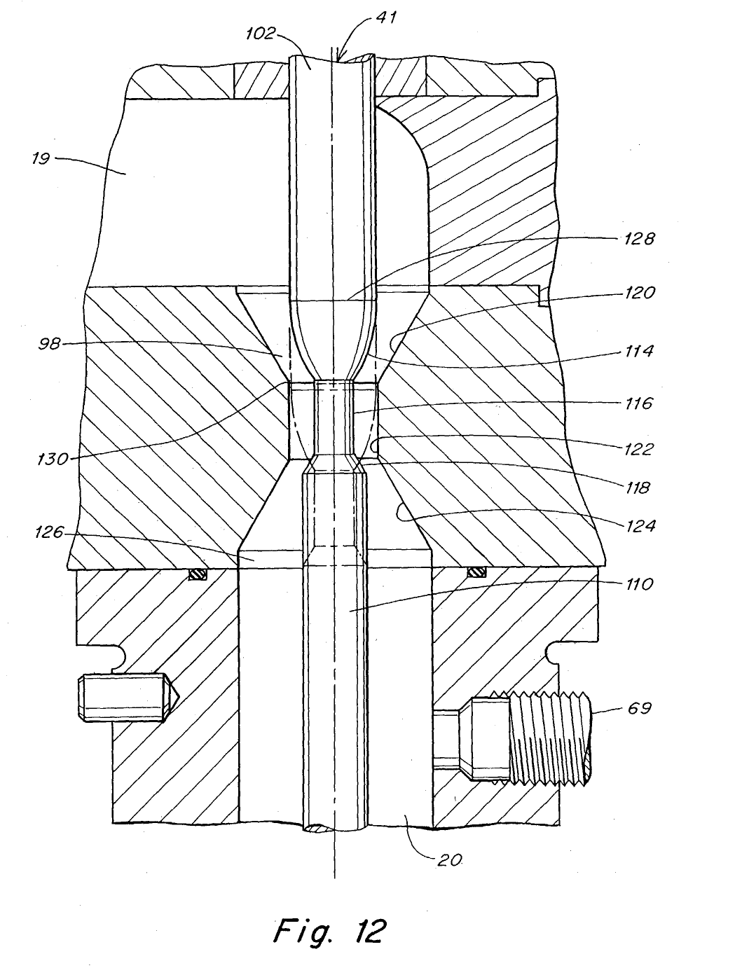

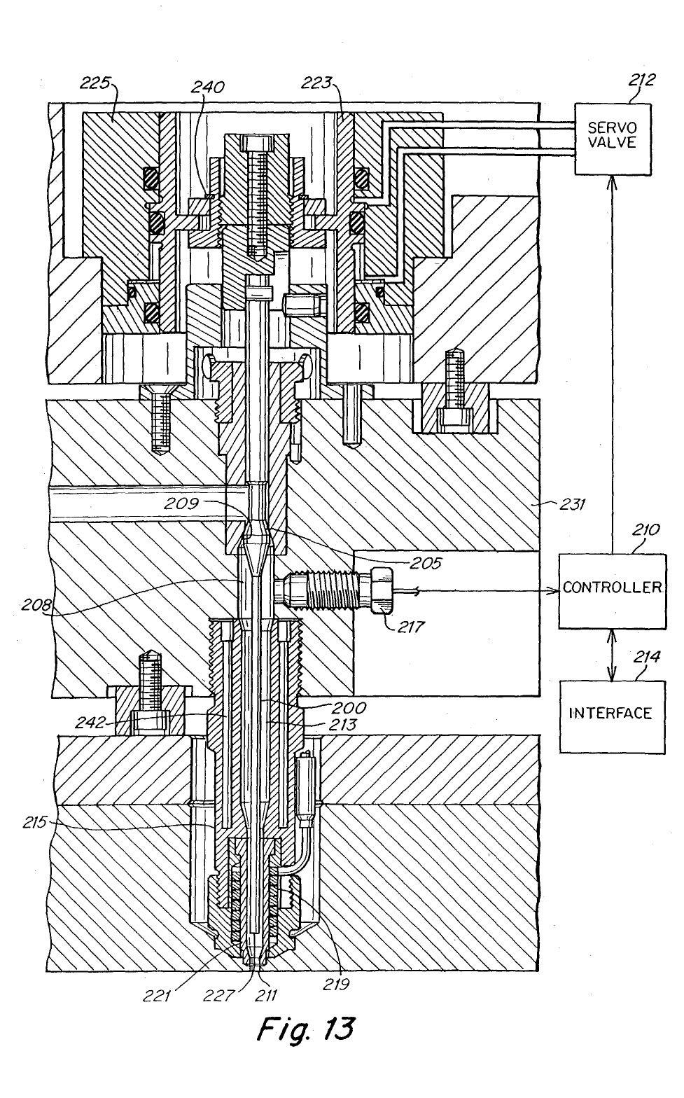

FIGS. 11 and 12 show an alternative hot-runner system having flow control in which the control of melt flow is still away from the gate as in previous embodiments. Use of the pressure transducer 69 and PID control system is the same as in previous embodiments. In this embodiment, however, the valve pin 41 extends past the area of flow control via extension 110 to the gate. The valve pin is shown in solid lines in the fully open position and in Phantom dashed lines in the closed position. In addition to the flow control advantages away from the gate described above, the extended valve pin has the advantage of shutting off flow at the gate with a tapered end 112 of the valve pin 41.

Extending the valve pin to close the gate has several advantages. First, it shortens injection cycle time. In previous embodiments thermal gating is used. In thermal gating, plastication does not begin until the part from the previous cycle is ejected from the cavity. This prevents material from exiting the gate when the part is being ejected. When using a valve pin, however, plastication can be performed simultaneously with the opening of the mold when the valve pin is closed, thus shortening cycle time by beginning plastication sooner. Using a valve pin can also result in a smoother gate surface on the part.

The flow control area is shown enlarged in FIG. 12. In solid lines the valve pin is shown in the fully open position in which maximum melt flow is permitted. The valve pin includes a convex surface 114 that tapers from edge 128 of the stem 102 of the valve pin 41 to a throat area 116 of reduced diameter. From throat area 116, the valve pin expands in diameter in section 118 to the extension 110 which extends in a uniform diameter to the tapered end of the valve pin.

In the flow control area the manifold includes a first section defined by a surface 120 that tapers to a section of reduced diameter defined by surface 122. From the section of reduced diameter the manifold channel then expands in diameter in a section defined by surface 124 to an outlet of the manifold 126 that communicates with the bore of the nozzle 20. FIGS. 11 and 12 show the support ring style nozzle similar to FIGS. 1-3. However, other types of nozzles may be used such as, for example, a threaded nozzle as shown in FIG. 8.

As stated above, the valve pin is shown in the fully opened position in solid lines. In FIG. 12, flow control is achieved and melt flow reduced by moving the valve pin 41 forward toward the gate thereby reducing the width of the control gap 98. Thus, surface 114 approaches surface 120 of the manifold to reduce the width of the control gap and reduce the rate of melt flow through the manifold to the gate.

To prevent melt flow from the manifold bore 19, and end the injection cycle, the valve pin is moved forward so that edge 128 of the valve pin, i.e., where the stem 102 meets the beginning of curved surface 114, will move past point 130 which is the beginning of surface 122 that defines the section of reduced diameter of the manifold bore 19. When edge 128 extends past point 130 of the manifold bore melt flow is prevented since the surface of the valve stem 102 seals with surface 122 of the manifold. The valve pin is shown in dashed lines where edge 128 is forward enough to form a seal with surface 122. At this position, however, the valve pin is not yet closed at the gate. To close the gate the valve pin moves further forward, with the surface of the stem 102 moving further along, and continuing to seal with, surface 122 of the manifold until the end 112 of the valve pin closes with the gate.

In this way, the valve pin does not need to be machined to close the gate and the flow bore 19 of the manifold simultaneously, since stem 102 forms a seal with surface 122 before the gate is closed. Further, because the valve pin is closed after the seal is formed in the manifold, the valve pin closure will not create any unwanted pressure spikes. Likewise, when the valve pin is opened at the gate, the end 112 of the valve pin will not interfere with melt flow, since once the valve pin is retracted enough to permit melt flow through gap 98, the valve pin end 112 is a predetermined distance from the gate. The valve pin can, for example, travel 6 mm. from the fully open position to where a seal is first created between stem 102 and surface 122, and another 6 mm. to close the gate. Thus, the valve pin would have 12 mm. of travel, 6 mm. for flow control, and 6 mm. with the flow prevented to close the gate. Of course, the invention is not limited to this range of travel for the valve pin, and other dimensions can be used.

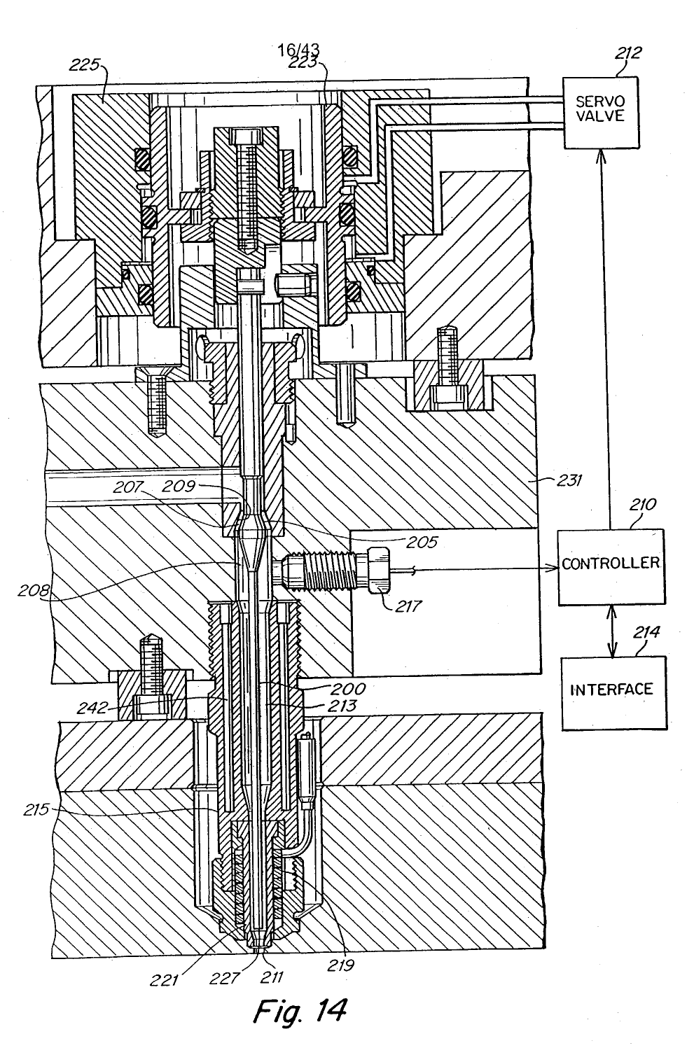

FIGS. 13-15 show another alternative hot runner system having flow control in which the control of material flow is away from the gate. Like the embodiment shown in FIGS. 11 and 12, the embodiment shown in FIGS. 13-15 also utilizes an extended valve pin design in which the valve pin closes the gate after completion of material flow.

Unlike the embodiment of FIGS. 11 and 12, however, flow control is performed using a “reverse taper” pin design, similar to the valve pin design shown in FIGS. 1-5.

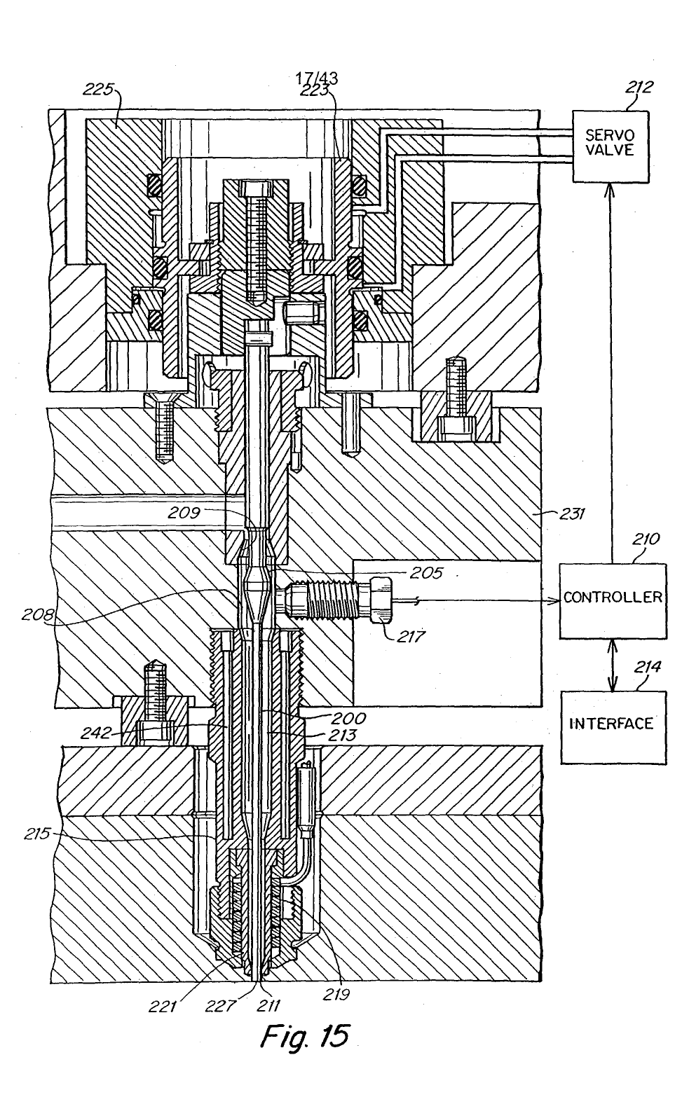

The valve pin 200 includes a reverse tapered control surface 205 for forming a gap 207 with a surface 209 of the manifold (see FIG. 14). The action of displacing the pin 200 away from the gate 211 reduces the size of the gap 207. Consequently, the rate of material flow through bores 208 and 214 of nozzle 215 and manifold 231, respectively, is reduced, thereby reducing the pressure measured by the pressure transducer 217. Although only one nozzle 215 is shown, manifold 231 supports two or more like nozzle arrangements shown in FIGS. 13-15, each nozzle for injecting into a single or multiple cavities.

The valve pin 200 reciprocates by movement of piston 223 disposed in an actuator body 225. This actuator is described in co-pending patent application Ser. No. 08/874,962. As disclosed in that application, the use of this actuator enables easy access to valve pin 200 in that the actuator body 225 and piston 223 can be removed from the manifold and valve pin simple by releasing retaining ring 240.

The reverse closure method offers an advantage over the forward closure method shown in FIGS. 6-9, 11 and 12, in that the action of the valve pin 200 moving away from the gate acts to displace material away from the gate, thereby assisting in the desired effect of decreasing flow rate and pressure.

In the forward closure method shown in FIGS. 6-9, forward movement of the pin is intended to reduce the control gap between the pin and the manifold (or nozzle) bore surface to thereby decrease flow rate and pressure. However, forward movement of the pin also tends to displace material toward the gate and into the cavity, thereby increasing pressure, working against the intended action of the pin to restrict flow.

Like the embodiment shown in FIGS. 6-9, and the embodiment shown in FIGS. 11 and 12, movement of the valve pin away from the gate is also intended to increase the flow rate and pressure. This movement, however, also tends to displace material away from the gate and decrease pressure. Accordingly, although either design can be used, the reverse taper design has been found to give better control stability in tracking the target pressure.

The embodiment shown in FIGS. 13-15 also includes a tip heater 219 disposed about an insert 221 in the nozzle. The tip heater provides extra heat at the gate to keep the material at its processing temperature. The foregoing tip heater is described in U.S. Pat. No. 5,871,786, entitled “Tip Heated Hot Runner Nozzle.” Heat pipes 242 are also provided to conduct heat uniformly about the injection nozzle 215 and to the tip area. Heat pipes such as these are described in U.S. Pat. No. 4,389, 002.

FIGS. 13-15 show the valve pin in three different positions. FIG. 13 represents the position of the valve pin at the start of an injection cycle. Generally, an injection cycle includes: 1) an injection period during which substantial pressure is applied to the melt stream from the injection molding machine to inject the material in the mold cavity; 2) a reduction of the pressure from the injection molding machine in which melt material is packed into the mold cavity and held at a relatively constant pressure; and 3) a cooling period in which the pressure decreases to zero and the article in the mold solidifies.

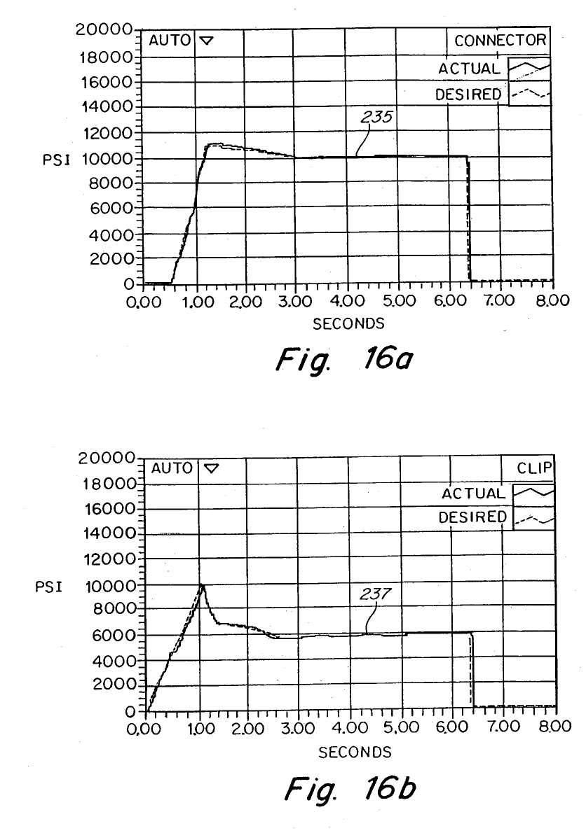

Just prior to the start of injection, tapered control surface 205 is in contact with manifold surface 209 to prevent any material flow. At the start of injection the pin 200 will be opened to allow material flow. To start the injection cycle the valve pin 200 is displaced toward the gate to permit material flow, as shown in FIG. 14. (Note: for some applications, not all the pins will be opened initially, for some gates pin opening will be varied to sequence the fill into either a single cavity or multiple cavities). FIG. 15 shows the valve pin at the end of the injection cycle after packing and holding. The part is ejected from the mold while the pin is in the position shown in FIG. 15.

As in previous embodiments, pin position will be controlled by a controller 210 based on pressure readings fed to the controller from pressure sensor 217. In a preferred embodiment, the controller is a programmable controller, or “PLC,” for example, model number 90-30PLC manufactured by GE-Fanuc. The controller compares the sensed pressure to a target pressure and adjusts the position of the valve pin via servo valve 212 to track the target pressure, displacing the pin forward toward the gate to increase material flow (and pressure) and withdrawing the pin away from the gate to decrease material flow (and pressure). In a preferred embodiment, the controller performs this comparison and controls pin position according to a PID algorithm. Furthermore, as an alternative, valve 212 can also be a high speed proportional valve.

The controller also performs these functions for the other injection nozzles (not shown) coupled to the manifold 231. Associated with each of these nozzles is a valve pin or some type of control valve to control the material flow rate, a pressure transducer, an input device for reading the output signal of the pressure transducer, means for signal comparison and PID calculation (e. g., the controller 210), means for setting, changing and storing a target profile (e. g., interface 214), an output means for controlling a servo valve or proportional valve, and an actuator to move the valve pin. The actuator can be pneumatic, hydraulic or electric. The foregoing components associated with each nozzle to control the flow rate through each nozzle are called a control zone or axis of control.

Instead of a single controller used to control all control zones, alternatively, individual controllers can be used in a single control zone or group of control zones.

An operator interface 214, for example, a personal computer, is used to program a particular target pressure profile into controller 210. Although a personal computer is used, the interface 214 can be any appropriate graphical or alpha numeric display, and could be directly mounted to the controller. As in previous embodiments, the target profile is selected for each nozzle and gate associated therewith by pre-selecting a target profile (preferably including at least parameters for injection pressure, injection time, pack and hold pressure and pack and hold time), programming the target profile into controller 210, and running the process.

In the case of a multicavity application in which different parts are being produced in independent cavities associated with each nozzle (a “family tool” mold), it is preferable to create each target profile separately, since different shaped and sized cavities can have different profiles which produce good parts.

For example, in a system having a manifold with four nozzles coupled hereto for injecting into four separate cavities, to create a profile for a particular nozzle and cavity, three of the four nozzles are shut off while the target profile is created for the fourth.

Three of the four nozzles are shut off by keeping the valve pins in the position shown in FIGS. 13 or 15 in which no melt flow is permitted into the cavity.

To create the target profile for the particular nozzle and cavity associated therewith, the injection molding machine is set at maximum injection pressure and screw speed, and parameters relating to the injection pressure, injection time, pack and hold pressure and pack and hold time are set on the controller 210 at values that the molder estimates will generate good parts based on part size, shape, material being used, experience, etc. Injection cycles are run for the selected nozzle and cavity, with alterations being made to the above parameters depending on the condition of the part being produced. When satisfactory parts are produced, the profile that produced the satisfactory parts is determined for that nozzle and cavity associated therewith. This process is repeated for all four nozzles (keeping three valve pins closed while the selected nozzle is profiled) until target profiles are ascertained for each nozzle and cavity associated therewith. Preferably, the acceptable target profiles are stored in computer member, for example, on a file stored in interface 214 and used by controller 210 for production. The process can then be run for all four cavities using the four particularized profiles.

Of course, the foregoing process of profile creation is not limited to use with a manifold having four nozzles, but can be used with any number of nozzles. Furthermore, although it is preferable to profile one nozzle and cavity at a time (while the other nozzles are closed) in a “family tool” mold application, the target profiles can also be created by running all nozzles simultaneously, and similarly adjusting each nozzle profile according the quality of the parts produced. This would be preferable in an application where all the nozzles are injecting into like cavities, since the profiles should be similar, if not the same, for each nozzle and cavity associated therewith.

In single cavity applications (where multiple nozzles from a manifold are injecting into a single cavity), the target profiles would also be created by running the nozzles at the same time and adjusting the profiles for each nozzle according to the quality of the part being produced. The system can also be simplified without using interface 214, in which each target profile can be stored on a computer readable medium in controller 210, or the parameters can be set manually on the controller.

FIG. 14 shows the pin position in a position that permits material flow during injection and/or pack and hold. As described above, when the target profile calls for an increase in pressure, the controller will cause the valve pin 200 to move forward to increase gap 207, which increases material flow, which increases the pressure sensed by pressure transducer 217. If the injection molding machine is not providing adequate pressure (i. e., greater than the target pressure), however, moving the pin forward will not increase the pressure sensed by transducer 217 enough to reach the target pressure, and the controller will continue to move the pin forward calling for an increase in pressure. This could lead to a loss of control since moving the pin further forward will tend to cause the head 227 of the valve pin to close the gate and attenuate material flow through and about the gate.

Accordingly, to prevent loss of control due to inadequate injection pressure, the output pressure of the injection molding machine can be monitored to alert an operator when the pressure drops below a particular value relative to the target pressure.

Alternatively, the forward stroke of the valve pin (from the position in FIG. 13 to the position in FIG. 14) can be limited during injection and pack and hold. In a preferred embodiment, the pin stroke is limited to approximately 4 millimeters. Greater or smaller ranges of pin movement can be used depending on the application. If adequate injection pressure is not a problem, neither of these safeguards is necessary.

To prevent the movement of the valve pin too far forward during injection and pack/hold several methods can be used. For example, a control logic performed by the controller 210 can be used in which the output signal from the controller to the servo valve is monitored. Based on this signal, an estimate of the valve pin position is made.

If the valve pin position exceeds a desired maximum, for example, 4 millimeters, then the forward movement of the pin is halted, or reversed slightly away from the gate. At the end of the injection cycle, the control logic is no longer needed, since the pin is moved to the closed position of FIG. 15 and attenuation of flow is no longer a concern.

Thus, at the end of the pack and hold portion of the injection cycle, a signal is sent to the servo valve to move the pin forward to the closed position of FIG. 15. Subsequent to the pack and hold period of time, the material is typically cooled for a selected period of time.

Other methods and apparatus for detecting and limiting forward displacement of the valve pin 200 can be used during injection and pack and hold. For example, the pressure at the injection molding machine nozzle can be measured to monitor the material pressure supplied to the manifold. If the input pressure to the manifold is less than the target pressure, or less than a specific amount above the target pressure, e. g., 500 p. s. i., an error message is generated.

Another means for limiting the forward movement of the pin is a mechanical or proximity switch which can be used to detect and limit the displacement of the valve pin towards the gate instead of the control logic previously described. The mechanical or proximity switch indicates when the pin travels beyond the control range (for example, 4 millimeters). If the switch changes state, the direction of the pin travel is halted or reversed slightly to maintain the pin within the desired range of movement.

Another means for limiting the forward movement of the pin is a position sensor, for example, a linear voltage differential transformer (LVDT) that is mounted onto the pin shaft to give an output signal proportional to pin distance traveled. When the output signal indicates that the pin travels beyond the control range, the movement is halted or reversed slightly.

Still another means for limiting the forward movement of the pin is an electronic actuator. An electronic actuator can be used to move the pin instead of the hydraulic or pneumatic actuator shown in FIGS. 13-15. An example of a suitable electronic actuator is shown in U.S. Pat. No. 6,294,122. Using an electronic actuator, the output signal to the servo valve motor can be used to estimate pin position, or an encoder can be added to the motor to give an output signal proportional to pin position. As with previous options, if the pin position travels beyond the control range, then the direction is reversed slightly or the position maintained.

At the end of the pack and hold portions of the injection cycle, the valve pin 200 is moved all the way forward to close off the gate as shown in FIG. 15. When the gate is closed off, the material in the mold is typically allowed to cool for a period of time selected to produce the best part before the next injection cycle is initiated. In the foregoing example, the full stroke of the pin (from the position in FIG. 13 to the position in FIG. 15) is approximately 12 millimeters. Of course, different ranges of movement can be used depending on the application.

The gate remains closed until just prior to the start of the next injection cycle when it is opened and moved to the position shown in FIG. 13. While the gate is closed, as shown in FIG. 15, the injection molding machine begins plastication for the next injection cycle as the part is cooled and ejected from the mold.

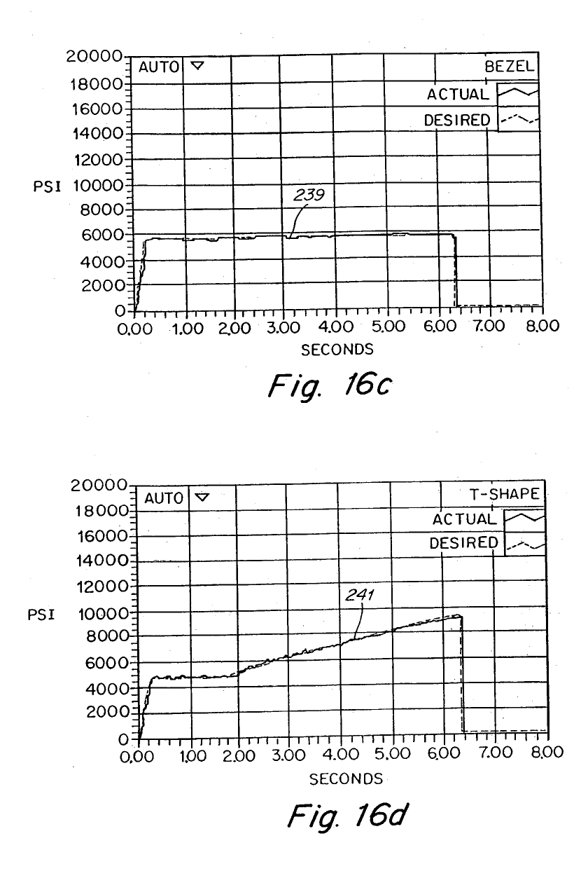

FIG. 16 shows time versus pressure graphs (235,237,239,241) of the pressure detected by four pressure transducers associated with four nozzles mounted in manifold block 231. The four nozzles are substantially similar to the nozzle shown in FIGS. 1315, and include pressure transducers coupled to the controller 210 in the same manner as pressure transducer 217.

The graphs of FIG. 16 (a-d) are generated on the user interface 214 so that a user can observe the tracking of the actual pressure versus the target pressure during the injection cycle in real time, or after the cycle is complete. The four different graphs of FIG. 16 show four independent target pressure profiles (“desired”) emulated by the four individual nozzles. Different target profiles are desirable to uniformly fill different sized individual cavities associated with each nozzle, or to uniformly fill different sized sections of a single cavity. Graphs such as these can be generated with respect to any of the previous embodiments described herein.

The valve pin associated with graph 235 is opened sequentially at. 5 seconds after the valves associated with the other three graphs (237,239 and 241) were opened at. 00 seconds. Referring back to FIGS. 13-15, just before opening, the valve pins are in the position shown in FIG. 13, while at approximately 6.25 seconds at the end of the injection cycle all four valve pins are in the position shown in FIG. 15. During injection (for example,. 00 to 1.0 seconds in FIG. 16b) and pack and hold (for example, 1.0 to 6.25 seconds in FIG. 16b) portions of the graphs, each valve pin is controlled to a plurality of positions to alter the pressure sensed by the pressure transducer associated therewith to track the target pressure.

Through the user interface 214, target profiles can be designed, and changes can be made to any of the target profiles using standard windows-based editing techniques.

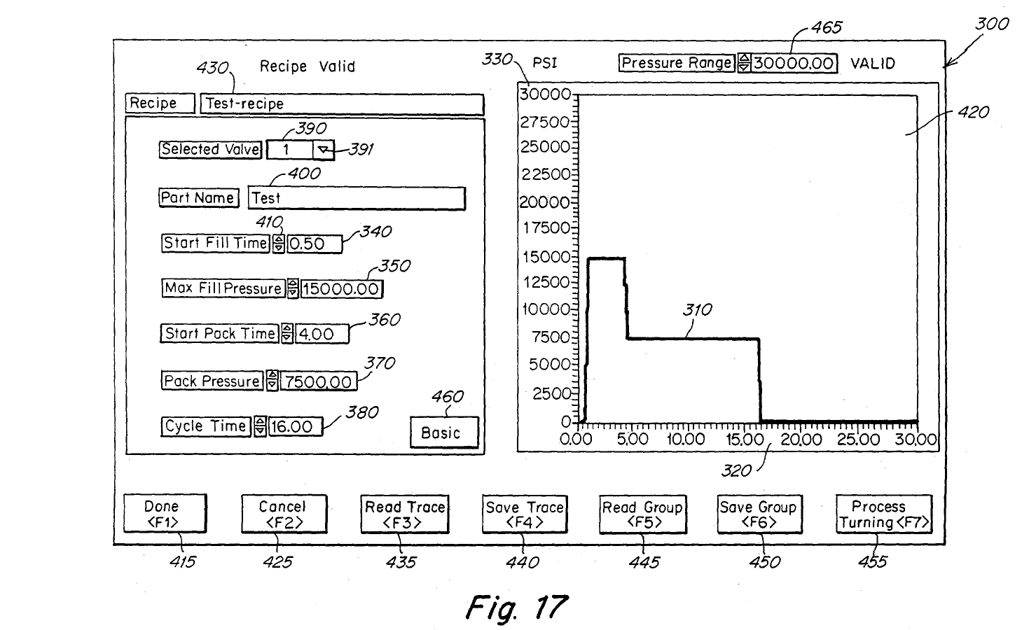

The profiles are then used by controller 210 to control the position of the valve pin. For example, FIG. 17 shows an example of a profile creation and editing screen icon 300 generated on interface 214.

Screen icon 300 is generated by a windows-based application performed on interface 214. Alternatively, this icon could be generated on an interface associated with controller 210. Screen icon 300 provides a user with the ability to create a new target profile or edit an existing target profile for any given nozzle and cavity associated therewith. Screen icon 300 and the profile creation text techniques described herein are described with reference to FIGS. 13-15, although they are applicable to all embodiments described herein.

A profile 310 includes (x, y) data pairs, corresponding to time values 320 and pressure values 330 which represent the desired pressure sensed by the pressure transducer for the particular nozzle being profiled. The screen icon shown in FIG. 17 is shown in a “basic” mode in which a limited group of parameters are entered to generate a profile. For example, in the foregoing embodiment, the “basic” mode permits a user to input start time displayed at 340, maximum fill pressure displayed at 350 (also known as injection pressure), the start of pack time displayed at 360, the pack and hold pressure displayed at 370, and the total cycle time displayed at 380.

The screen also allows the user to select the particular valve pin they are controlling displayed at 390, and name the part being molded displayed at 400. Each of these parameters can be adjusted independently using standard windows-based editing techniques such as using a cursor to actuate up/down arrows 410, by clicking on a pull-down menu arrow 391, the user can select different nozzle valves in order to create, view or edit a profile for the selected nozzle valve and cavity associated therewith. Also, a part name 400 can be entered and displayed for each selected nozzle valve.

The newly edited profile can be saved in computer memory individually, or saved as a group of profiles for a group of nozzles that inject into a particular single or multicavity mold. The term “recipe” is used to describe a group of profiles for a particular mold and the name of the particular recipe is displayed at 430 on the screen icon.

To create a new profile or edit an existing profile, first the user selects a particular nozzle valve of the group of valves for the particular recipe group being profiled. The valve selection is displayed at 390. The user inputs an alpha/numeric name to be associated with the profile being created, for family tool molds this may be called a part name displayed at 400. The user then inputs a time displayed at 340 to specify when injection starts. A delay can be with particular valve pins to sequence the opening of the valve pins and the injection of melt material into different gates of a mold.

The user then inputs the fill (injection) pressure displayed at 350. In the basic mode, the ramp from zero pressure to max fill pressure is a fixed time, for example, 3 seconds. The user next inputs the start pack time to indicate when the pack and hold phase of the injection cycle starts. The ramp from the filling phase to the packing phase is also fixed time in the basic mode, for example, at about 0.3 seconds.

The final parameter is the cycle time which is displayed at 380 in which the user specifies when the pack and hold phase (and the injection cycle) ends. The ramp from the pack and hold phase to zero pressure at about 16.5 seconds will be instantaneous when a valve pin is used to close the gate, as in the embodiment of FIG. 13, or slower in a thermal gate (see FIG. 1) due to the residual pressure in the cavity which will decay to zero pressure once the part solidifies in the mold cavity. The “cool” time typically begins upon the drop to zero pressure and lasts to the end of the cycle, e.g. 6.4-8.00 seconds in FIGS. 16c, 16d and 16.5-30.0 seconds in FIG. 17.

User input buttons 415 through 455 are used to save and load target profiles.

Button 415 permits the user to close the screen. When this button is clicked, the current group of profiles will take effect for the recipe being profiled. Cancel button 425 is used to ignore current profile changes and revert back to the original profiles and close the screen. Read Trace button 435 is used to load an existing and saved target profile from memory. The profiles can be stored in memory contained in the interface 215 or the controller 210. Save trace button 440 is used to save the current profile. Read group button 445 is used to load an existing recipe group. Save group button 450 is used to save the current group of target profiles for a group of nozzle valve pins. The process tuning button 455 allows the user to change the PID settings (for example, the gains) for a particular nozzle valve in a control zone. Also displayed is a pressure range 465 for the injection molding application.

Button 460 permits the user to toggle to an “advanced” mode profile creation and editing screen. The advanced profile creation and editing screen is shown in FIG. 18.

The advanced mode allows a greater number of profile points to be inserted, edited, or deleted than the basic mode. As in the basic mode, as the profile is changed, the resulting profile is displayed.

The advanced mode offers greater profitability because the user can select values for individual time and pressure data pairs. As shown in the graph 420, the profile 470 displayed is not limited to a single pressure for fill and pack/hold, respectively, as in the basic mode. In the advanced mode, individual (x, y) data pairs (time and pressure) can be selected anywhere during the injection cycle.

To create and edit a profile using advanced mode, the user can select a plurality of times during the injection cycle (for example 16 different times), and select a pressure value for each selected time. Using standard windows-based editing techniques (arrows 475) the user assigns consecutive points along the profile (displayed at 478), particular time values displayed at 480 and particular pressure values displayed at 485.

The next button 490 is used to select the next point on the profile for editing.

Prev button 495 is used to select the previous point on the profile for editing. Delete button 500 is used for deleting the currently selected point. When the delete button is used the two adjacent points will be redrawn showing one straight line segment.

The add button 510 is used to add a new point after the currently selected point in which time and pressure values are entered for the new point. When the add button is used the two adjacent points will be redrawn showing two segments connecting to the new point.

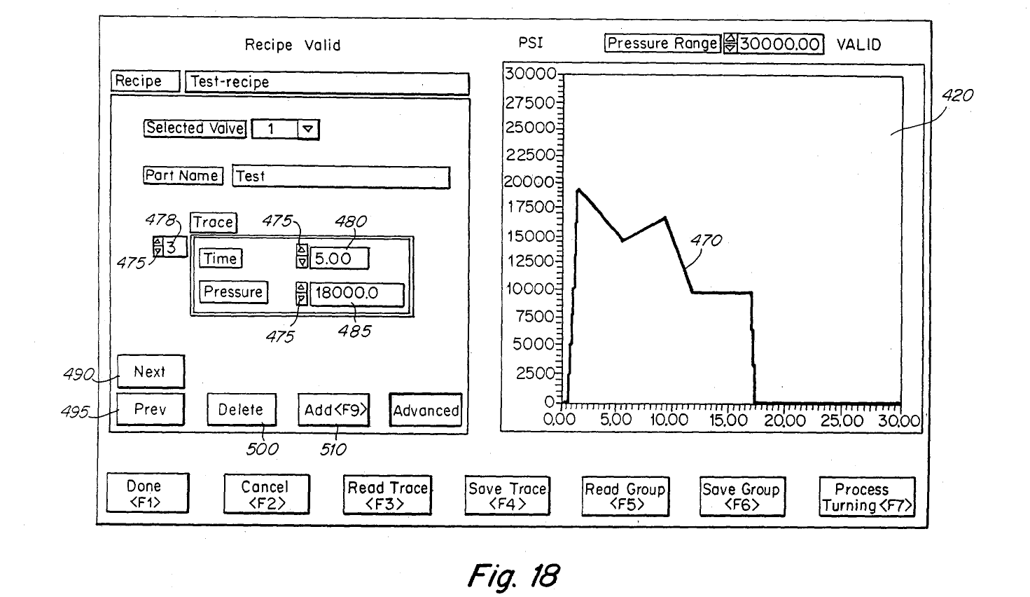

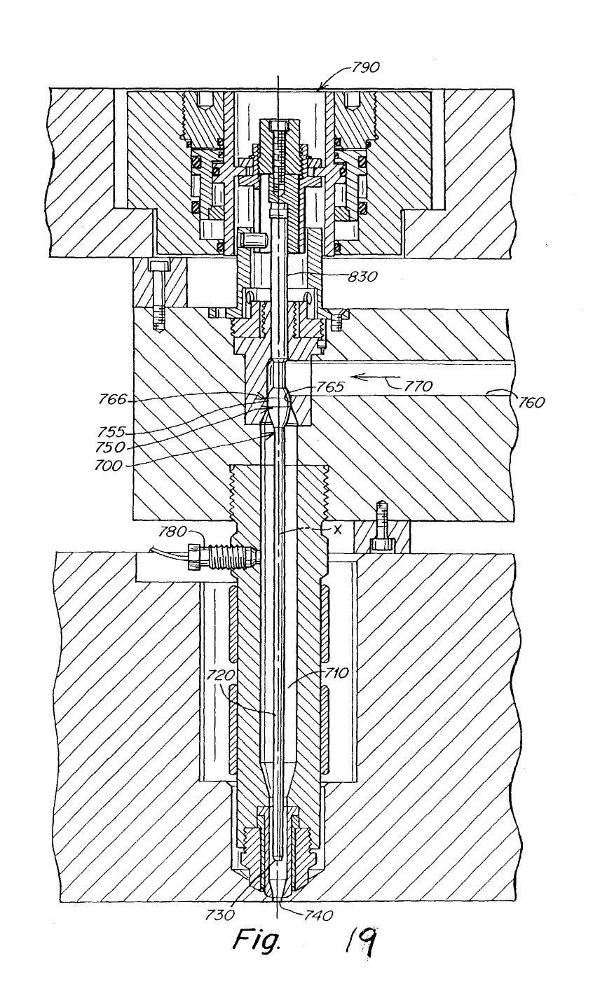

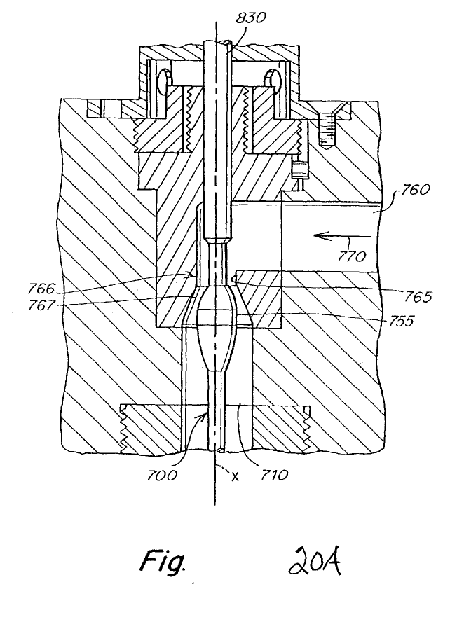

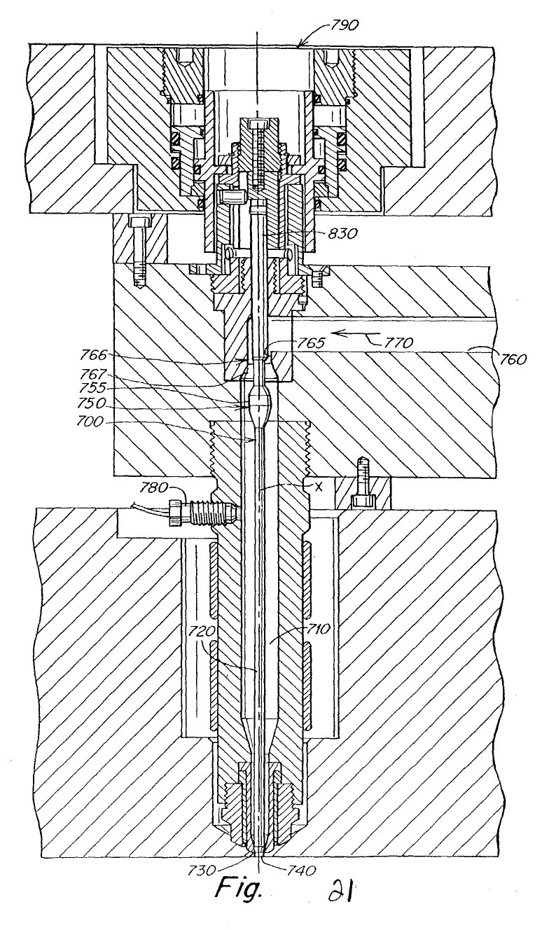

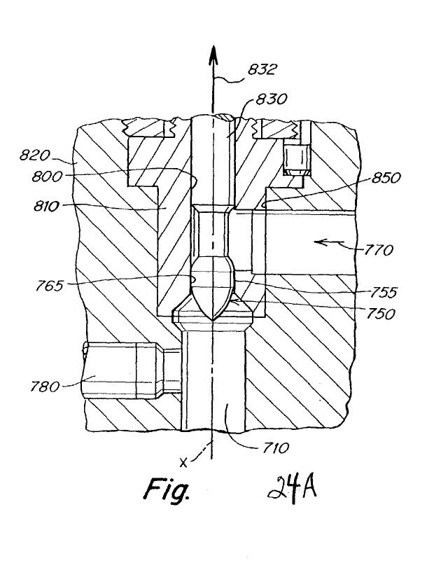

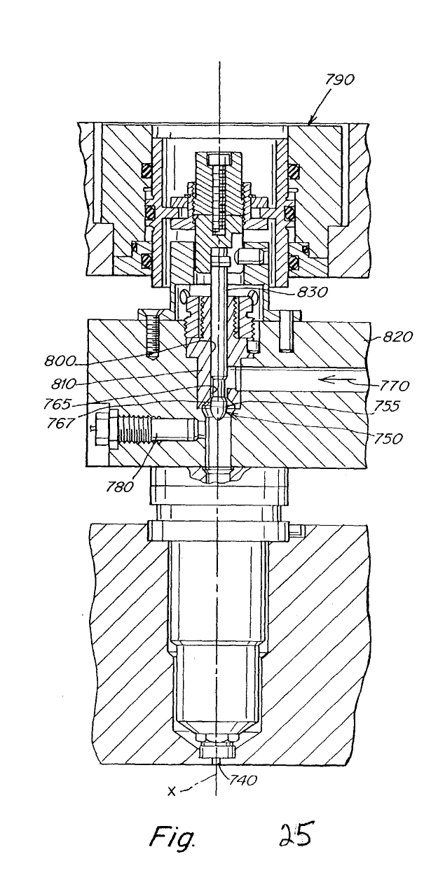

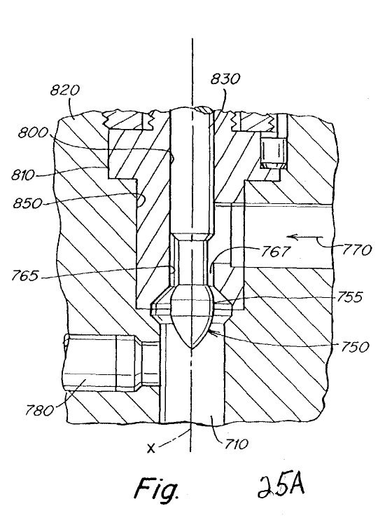

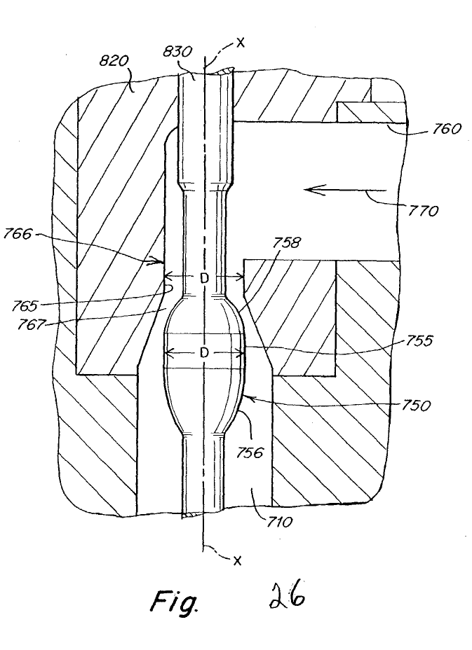

FIG. 19 shows a valve pin 700 having a smooth outer surfaced curvilinear bulbous protrusion 750 for controlling melt flow from manifold channel 760 to nozzle channel 710. The pin 700 is slidably mounted in nozzle channel 710 having a distal extension section 720 having a tip end 730 for closing off gate 740 when the pin is appropriately driven to the position shown in FIG. 21. The pin 700, 830 is controllably slidable along its axis Z. The bulbous protrusion 750 as shown in FIGS. 19, 19A is in a flow shut-off position where the outer surface of a maximum diameter section 755 of the bulb makes engagement contact with a complementary shaped interior surface of the channel 765 sufficient to prevent melt flow 770 from passing through the throat section 766 where and when the bulb surface 755 engages the inner surface 765 of the flow channel. As perhaps best shown in FIG. 26, the bulb 750 has an intermediate maximum diameter section which is intermediate an upstream smooth curvilinear surfaced portion 820 and a downstream smooth curvilinear surfaced portion 810. Melt flow 900 flowing under pressure from manifold or hotrunner channel 770 toward nozzle channel 710 passes through flow controlling passage 767. The melt flow is slower the narrower passage 767 is and faster the wider that passage 767 is. Passage 767 may be controllably made narrower or wider by controlled CPU operation of actuator 790 as described above with reference to other embodiments via an algorithm which receives sensor variable signals from a sensor such as sensor 780. In the FIGS. 19-26 embodiments, the passage 767 is gradually made wider and flow increased by downstream movement of the bulb 750 toward the gate 740. By contrast, in the FIG. 27 embodiment, the passage 767 is made narrower by downstream movement of the bulb 750 from the position shown in FIG. 27 toward the throat 766 restriction section, and made wider by upstream movement of the bulb 750 away from the gate 740.

As shown in FIG. 26, the maximum diameter section typically has a straight surface 755 forming a cylindrical surface on the exterior of the bulb 750 having a diameter X. The throat 766 has a complementary straight interior surface 765 in the form of a cylinder having the same diameter X as the surface 755. Thus as the bulb 750 is moved in an upstream direction (away from the gate), from the position shown in FIG. 26, the flow controlling restriction 767 gets narrower and the melt flow 900 is gradually slowed until the surface 755 comes into engagement with surface 765 at which point flow is stopped at the throat 766. The same sequence of operation events occurs with respect to all of the embodiments shown in FIGS. 19-26. The maximum diameter surface 755 does not necessarily need to be cylindrical in shape. Surface 755 could be a finite circle which mates with a complementary diametrical circle on mating surface 765. The precise shape of surface 755 may be other than circular or round; such surface 755 could alternatively be square, triangular, rectangular, hexagonal or the like in cross-section and its mating surface 765 could be complementary in shape.

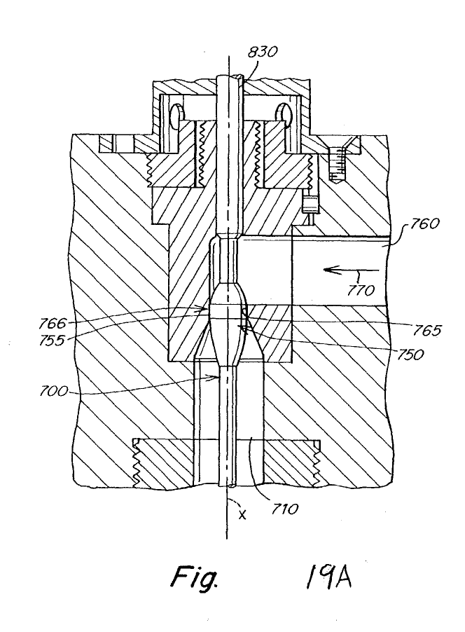

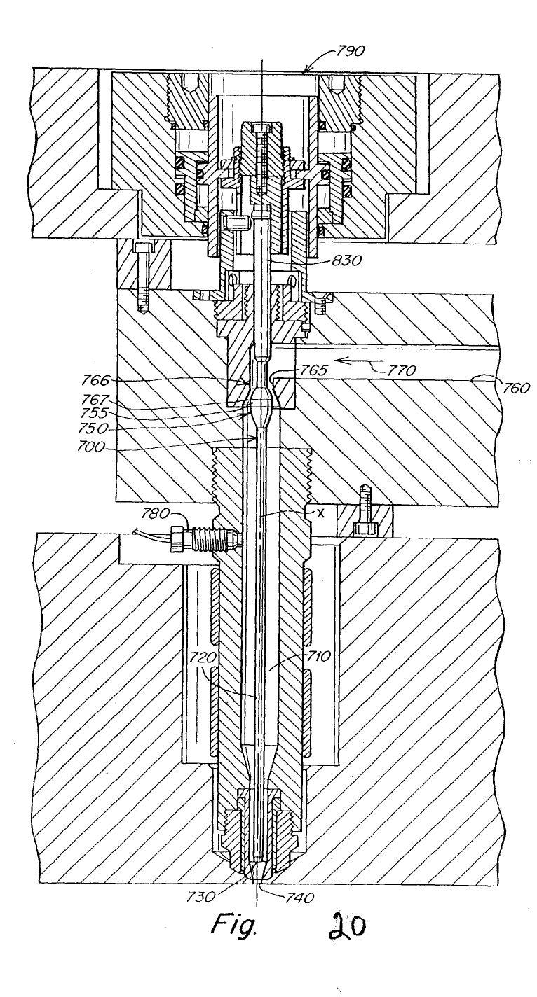

FIGS. 21, 21A show a third position where the end of the extended pin closes off flow through gate 740. FIGS. 19, 19A show a position where flow 900 is shutoff at throat 766. FIGS. 20, 20A show a pin/bulb position where flow 900 is being controlled to flow at a preselected rate. Any one or more positions where the bulb surface 755 is further or closer to surface 765 may be controllably selected by the CPU according to the algorithm resident in the CPU, the flow rate varying according to the precise position of the bulb surface 755 relative to the mating surface 765.

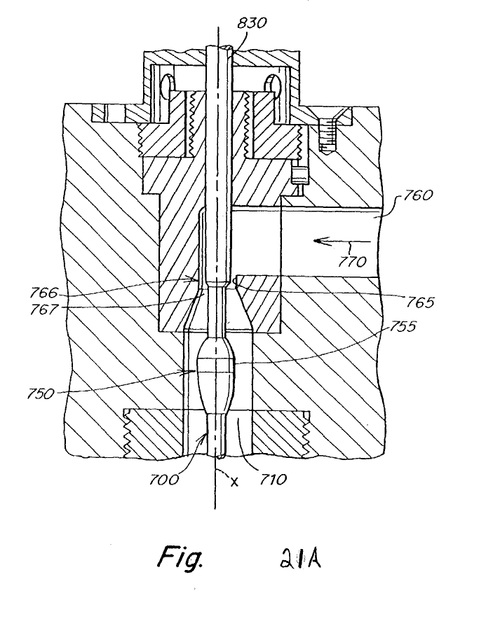

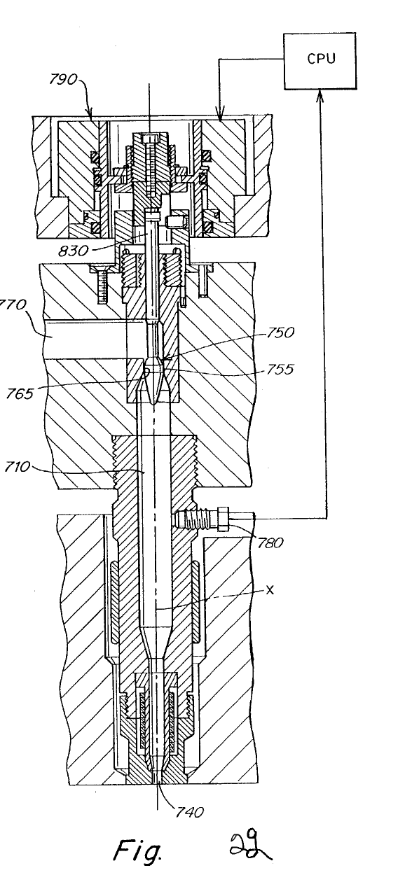

FIGS. 22, 23 show an embodiment where the pin does not have a distal end extension for closing off the gate 740 as the FIGS. 19-21 embodiment may accomplish. In such an embodiment, the algorithm for controlling flow does not have a third position for closing the gate 740.

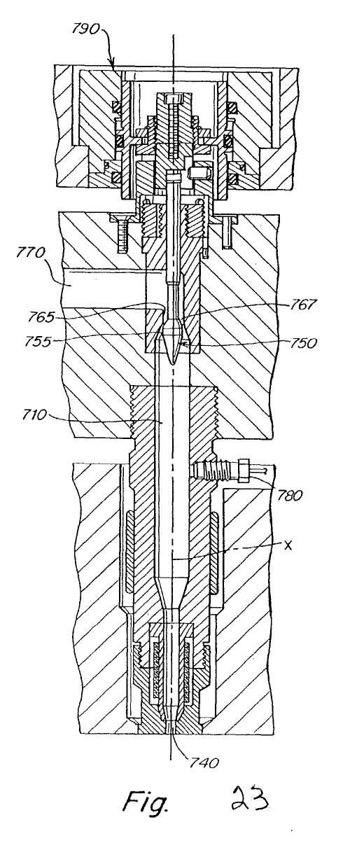

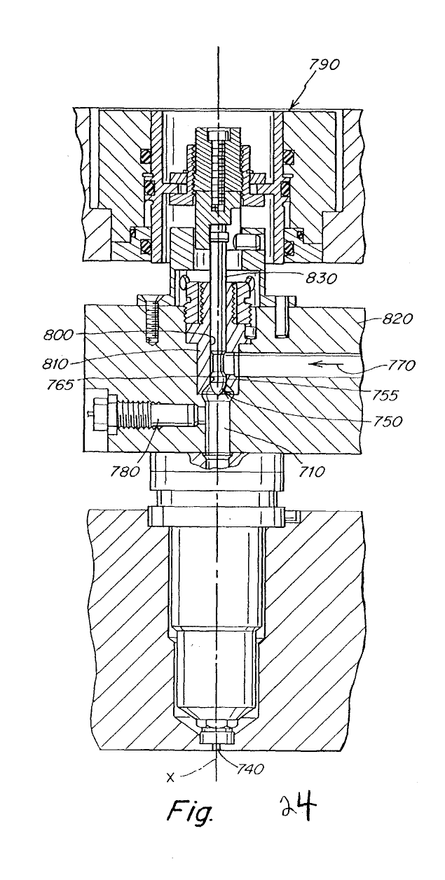

FIGS. 24-25A and 27 show an embodiment where the longitudinal aperture 800 in which the pin 830 is slidably mounted in bushing or mount 810 has the same or a larger diameter than the maximum diameter surface 755 of bulb 750. The aperture 800 extends through the body or housing of heated manifold or hotrunner 820 and thus allows pin 830 to be completely removed by backwards or upstream withdrawal 832, FIG. 24A, out of the top end of actuator 790 for pin replacement purposes without the necessity of having to remove mount or bushing 810 in order to replace/remove pin 830 when a breakage of pin 830 may occur. The bushing or mount 810 is typically press fit into a complementary mounting aperture 850 provided in the body or housing of manifold or hotrunner 820 such that a fluid seal is formed between the outer surface of bushing or mount 810 and aperture 850. The central slide aperture for pin 830 extends the length of the axis of actuator 790 such that pin 830 may be manually withdrawn from the top end of actuator 790.

As described above with reference to FIGS. 1-18, the slidable back and forth movement of a pin 830 having a bulb 750, FIGS. 19-27, is controllable via an algorithm residing in CPU or computer, FIG. 22 which receives one or more variable inputs from one or more sensors 780.

The melt flow 900 is readily controllable from upstream channel 770 to downstream 710 channel by virtue of the ready and smooth travel of the melt over first the upstream smooth curvilinear surface 820 past the maximum diameter surface 755 and then over the smooth downstream curvilinear surface 810. Such smooth surfaces provide better control over the rate at which flow is slowed by restricting passage 767 or speeded up by making passage 767 wider as pin 830 is controllably moved up and down. The inner surface 765 of throat section 766 is configured to allow maximum diameter surface 755 to fit within throat 766 upon back and forth movement of bulb 750 through throat 766.

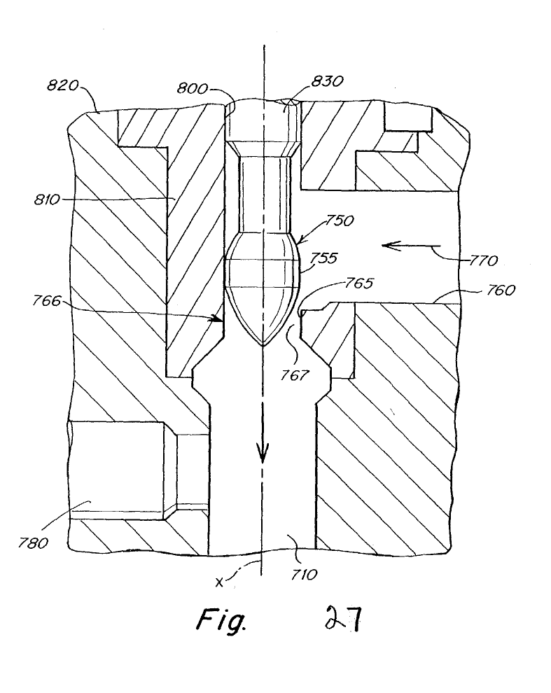

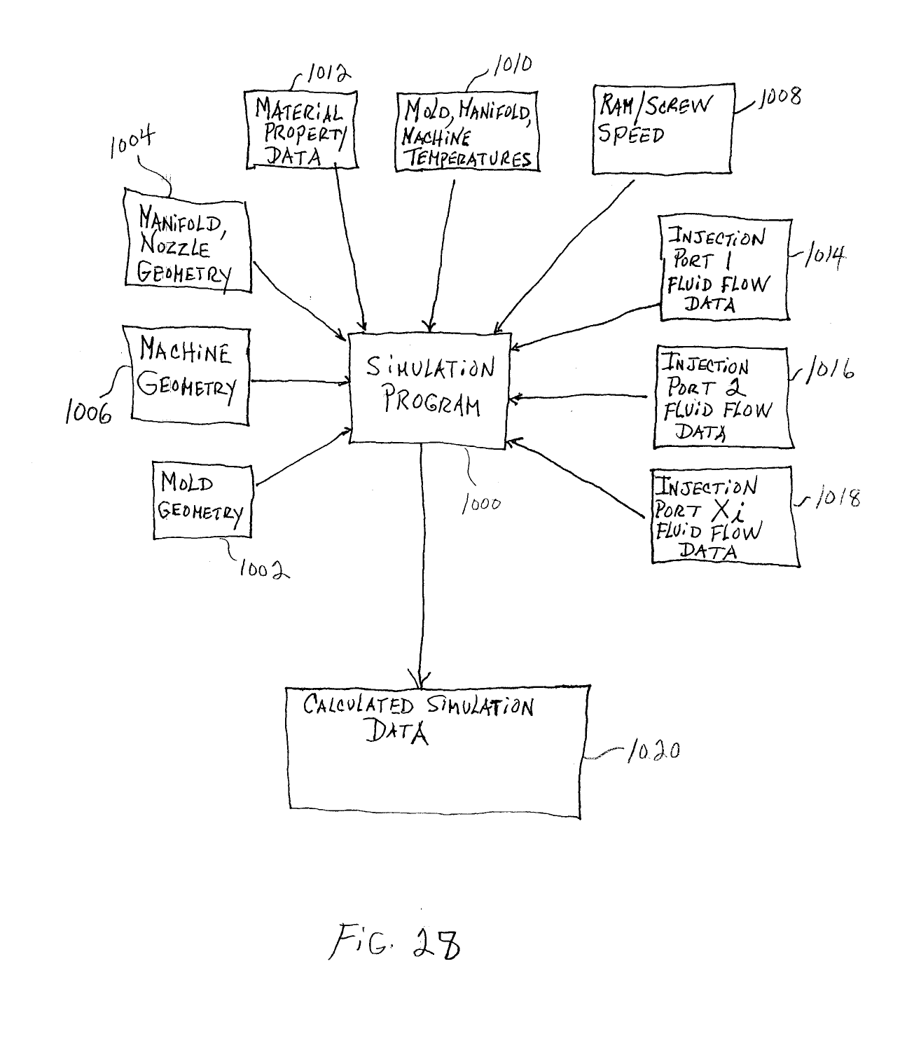

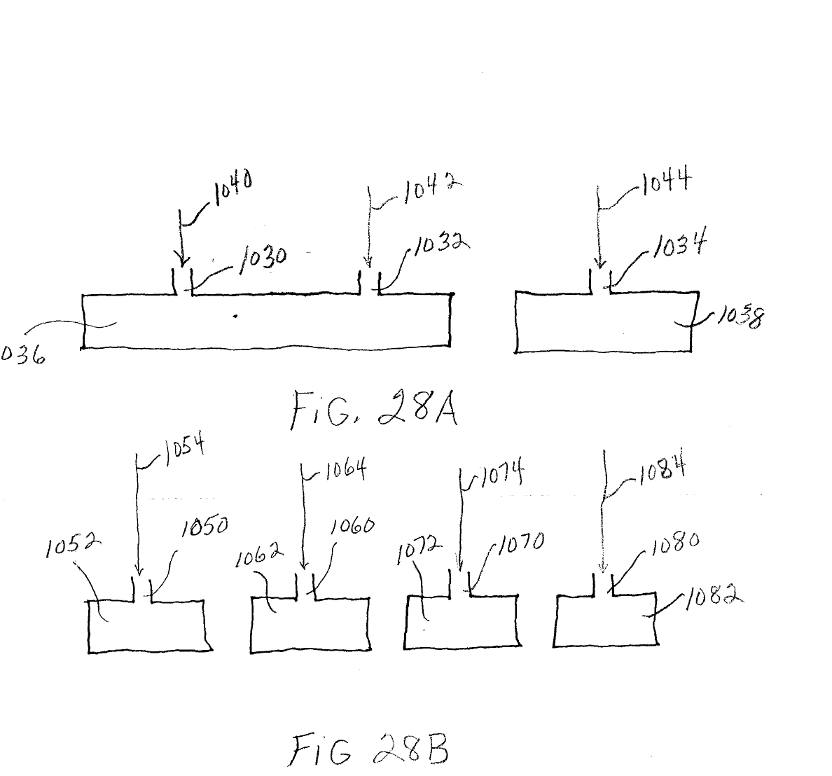

FIG. 28 shows a simulation program 1000 according to the invention. The program is executable by a conventional computer or other suitable electronic data processing device and is stored as a set of digital instructions on an appropriate medium. The program 1000 typically includes at least instructions for processing data comprising the geometry of the molds 1002, the geometry of the fluid flow channels of the hotrunners or fluid distribution manifolds and injection nozzles of the injection apparatus 1004, the geometry of the barrel of the injection mold machine 1006, the velocity of the ram/screw 1008, the temperatures of the molds, barrel and hotrunner equipment 1010 and selected intrinsic properties 1012 of the material (polymer, plastic, metal or the like) to be injected such as melt temperature, freezing point, shear rate or value, density, molecular weight, and the like.

Simulation program 1000, FIG. 28, includes instructions for receiving and processing data indicative of fluid flow that occurs locally at one or more locations 1014, 1016, 1018 downstream of the exit of the machine barrel and leading to one or more separate injection ports. Such downstream locations are located within the hotrunner channels, injection nozzles or within the mold cavities of the injection mold apparatus. As described in detail below, programs according to the invention may include instructions for processing additional data together with the data inputs 1002-14 to produce a resultant simulation of injection cycle data 1020.

Data indicative of flow rate typically comprises a fluid property that is readily correlatable to or convertible by an algorithm to the time or rate of filling of the mold cavity. Fluid pressure leading to or through an injection port is one example of flow rate data. The position of a mechanical flow controller mechanism such as a valve pin, rotary valve, plunger or ram; the position of an actuator that can be used to control movement of a pin, rotary valve, plunger or ram; the force or pressure exerted by an actuating mechanism (e.g. hydraulic, pneumatic actuator), electric motor, ram or the like; the electrical power or hydraulic or pneumatic pressure that is used to drive an actuating mechanism, motor, ram or the like during an injection cycle.

A program according to the invention may generate a set of simulated data representing selected characteristics of the injection process at any single point or points in time over an injection cycle. Or, a simulation of a cycle over the entire period of the injection cycle may be generated. Where an entire injection cycle is generated, data indicative of flow rate is typically input as profile of the acquired data over an entire injection cycle.

As described in greater detail below with reference to FIGS. 16-17, flow rate data for an entire cycle typically comprises a continuous profile or plot over time. Such data is preferably estimated by the user based on prior experience with operating a machine having the same or similar components and size of mold cavity as/to the system and cavity to be simulated. The data of FIGS. 16, 17 was obtained by actual operation of a machine to fill actual mold cavities. In practice, the data input to a simulation program is estimated, not actually generated, based on experience obtained with previously existing molding systems and mold cavities as, for example, the data of FIGS. 16-17 were obtained using an actual operating system.

With reference to FIGS. 16-17, at the beginning of a typical injection cycle, fluid pressure within the nozzle bore and within the mold cavity increases sharply over a relatively short period of time when the mold cavity is being filled, i.e. during the “fill time” portion of the injection cycle (e.g. from 0.00 to about 0.2-0.3 seconds in FIGS. 16c, 16d). After the mold is filled with fluid, the injection cycle continues for one or more periods of time where the filled mold cavity is packed, held and cooled. During the “pack” and “hold” times of the injection cycles, injection pressure is held at an elevated pressure and is varied to a generally lesser degree than during the fill time (e.g. from the period of about 0.3 to about 2.00 seconds as shown in FIGS. 16a, 16b). During the pack time, a relatively small amount of fluid material can continue to fill small spaces left in the mold cavity. During the hold time, the material in the filled mold cavity is held under pressure to assist in minimizing shrinkage and/or warpage of the material injected into the cavity. Similar to pack time, injection pressure is typically held at an elevated level for an extended period of time relative to the fill time (e.g. from the period of about 2 to about 6.4 seconds as shown in FIGS. 16a, 16b, 16c, 16d). Pack and hold time collectively is typically more than about four (4) times the length of fill time. As can be readily imagined, the pressure of the fluid recorded is indicative of and relates directly to the rate of flow of the fluid through the nozzles and their exit/injection ports into their associated cavities. The simulation program preferably includes instructions that utilize such pressure data as an input, or otherwise convert such pressure data to flow rate data, to generate a simulation of the flow of fluid through the one or more nozzles and their associated injection ports and cavities over an entire injection cycle. The program may include instructions to utilize the pressure data directly in generating the simulation data. The output of the simulation program may comprise single items of data, a table of data, a video, a series of images or moving image of either of both of the fluid flow and selected properties of the fluid (e.g. temperature, pressure, shear, density, flow rate, viscosity) throughout the entire injection molding apparatus or through selected portions or positions of/within the flow path of the injection molding apparatus, i.e. the machine, the hotrunner system, the nozzles and the mold cavities.

Given the geometry of the flow path and flow channels as an input and given other operating parameters as inputs (e.g. fluid pressure, fluid shear, fluid viscosity, fluid temperature at selected locations), numerous characteristics, properties and operating parameters of the fluid and the injection cycle can be simulated by a program according to the invention. Preferably, a program according to the invention includes algorithms/instructions for using/processing geometrical data representative of the system's flow channels, bores or mold cavities together with fluid pressure, temperature and shear or viscosity data to calculate a simulation of an injection cycle.

Data indicative of fluid flow rate other than pressure can be used in other embodiments of the invention. Such alternative programs/algorithms may have instructions for processing the following as variables:

position of a flow controlling valve pin or actuator cylinder;

force or pressure exerted on or by a flow controlling valve pin, actuator cylinder, ram, screw or motor;

energy or power used to operate a flow controlling actuator, ram, motor or the like;

flow rate recorded by a mechanical, optical or electronic sensing flowmeter;

flow volume injected over time by a machine ram/screw;

velocity of movement of a flow controlling component such as valve pin, alternative ram, plunger, rotary valve or the like.

As described with respect to the FIGS. 16-17 profile of fluid pressure data, a similar profile of data for any of the above variables over the time of an injection cycle may be used and processed in a program according to the invention to generate a simulation.

Most preferably a program according to the invention generates data representative of the rate or position of fluid flow within and throughout the mold cavity(ies). Other values/parameters that a simulation program according to the invention can include instructions/algorithms for calculating are:

Stress, pressure, shear rate and temperature values throughout the material that is injected within and throughout the mold cavity;

Fill time, pack time, hold time (after pack) and cool time of the simulated injection cycle;

Air traps within and throughout the mold cavity

The processor or computer which executes the programs and its associated algorithms includes conventional digital data storage or memory interconnected to the set or sets of instructions for inputting selected data for processing and for storing data which is calculated for eventual display to the user. The simulation programs according to the invention may be written in any conventional language for processing and generating large amounts of data such as C, C+and C++. The output of a simulation program may be printed on paper or displayed on a monitor in any conventional format, e.g. in graph, plot, image or other format. The computer used for such processing, storage and output of data comprises one or more conventional digital electronic processors and memory devices, e.g. Intel Pentium or AMD processors having processing speeds of at least about 100 Mhz.

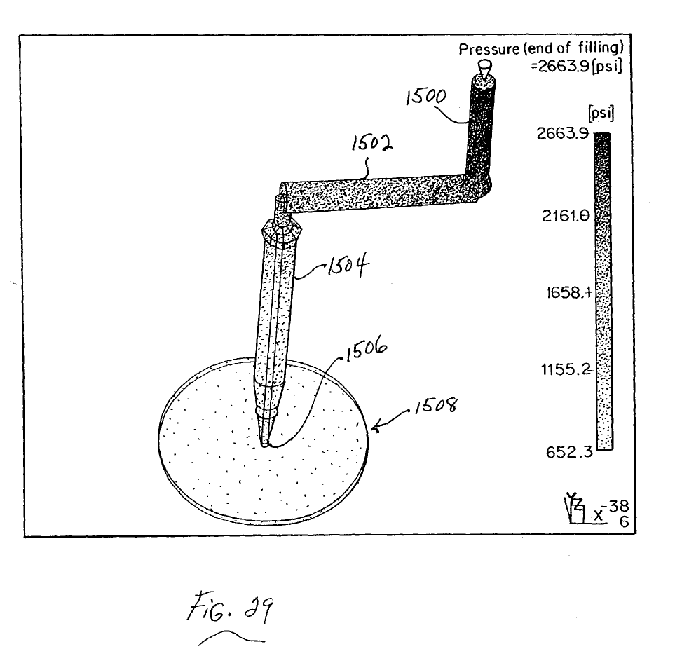

FIGS. 29, 30, 31, 32 and 33 show examples of three dimensional image and graph outputs with accompanying selected data which a program according to the invention can generate. The data shown in FIGS. 29-33 was obtained using Moldflow, Inc. Moldflow Plastics Insight (MPI) MPX software without input of flow rate data occurring downstream of the machine barrel exit. A program according to the invention includes instructions for use of flow rate data that can be controllably effected one or more locations downstream of the barrel exit independent of flow rate control through the main injection barrel itself.

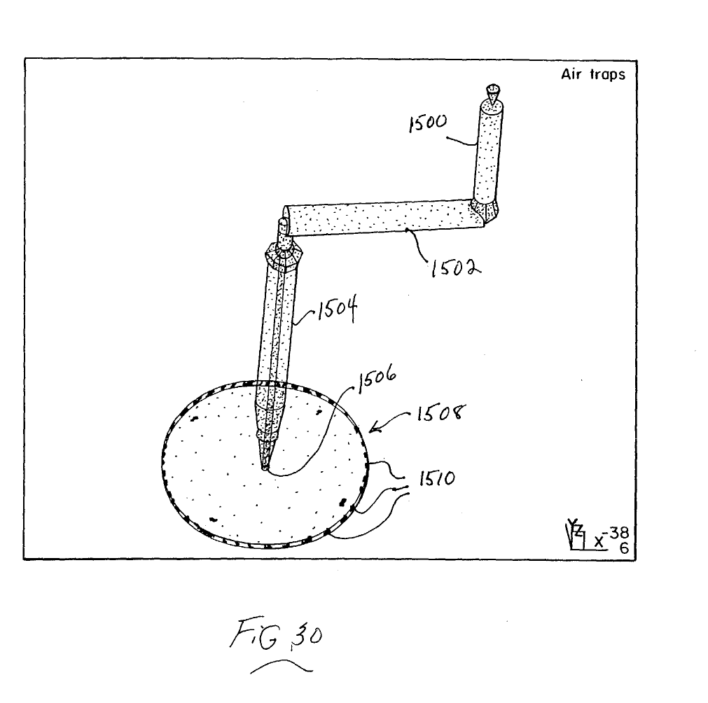

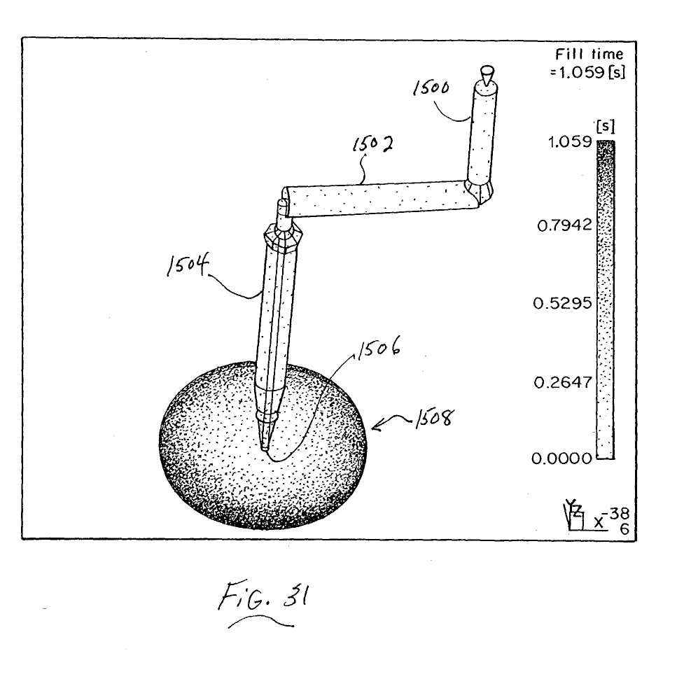

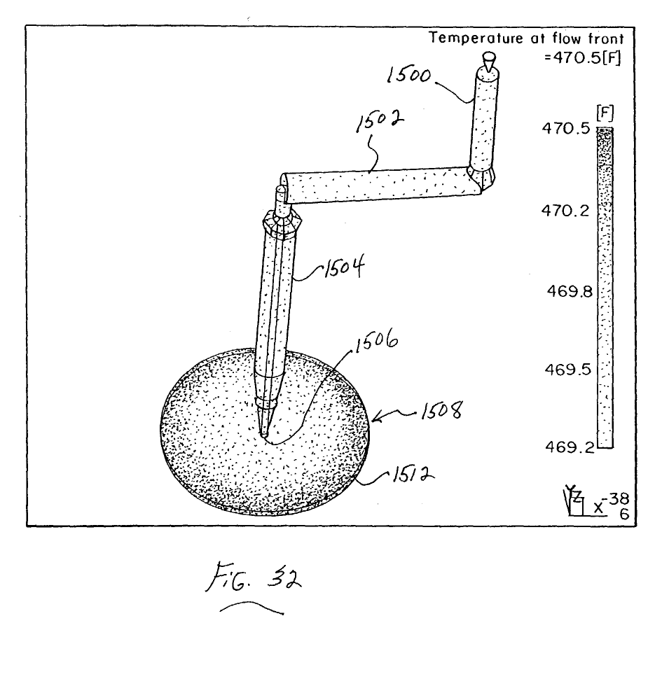

FIGS. 29-32 depict a semi-schematic three dimensional representation of hotrunner channels 1500, 1502 leading to an injection nozzle 1504 having an exit or injection port 1506 to a mold cavity 1508. The three dimensional representations shown in FIGS. 29-32 are examples of the type of three dimensional modeling data that is initially generated by a conventional modeling program such as ProEngineer or Solidworks and input into a program according to the invention. FIG. 29 shows a gradient shaded (in black and white or color) three-D still image representation of fluid pressure calculated at a selected point in time at the end of a simulated filling cycle for the part or cavity 1508 depicted. As shown, the gradient of depth in shading in the three-dimensional representation is readily correlatable in number or degree to the depth of shading along the scale bar on the right hand side of FIG. 29. FIG. 30 shows a three dimensional representation of the location of air traps 1510 that may be formed in a fully injected part 1508, the location of the air traps 110 having been calculated according to an algorithm based on at least the minimum inputs of geometry and other data described above. FIG. 31 shows a gradient shaded three-dimensional image of the fill time for the various portions of the part or cavity 1508, the depth of shading or color or both in the three dimensional figure corresponding in depth of shading or color or both to the scale on the right hand side of FIG. 31. FIG. 32 shows a three-D still image representation of the gradient of temperature in the part 1508 and other shown components of the injection apparatus, showing and highlighting the temperature at the flow front, i.e. the outer circumference 1512 of the round part 1508.

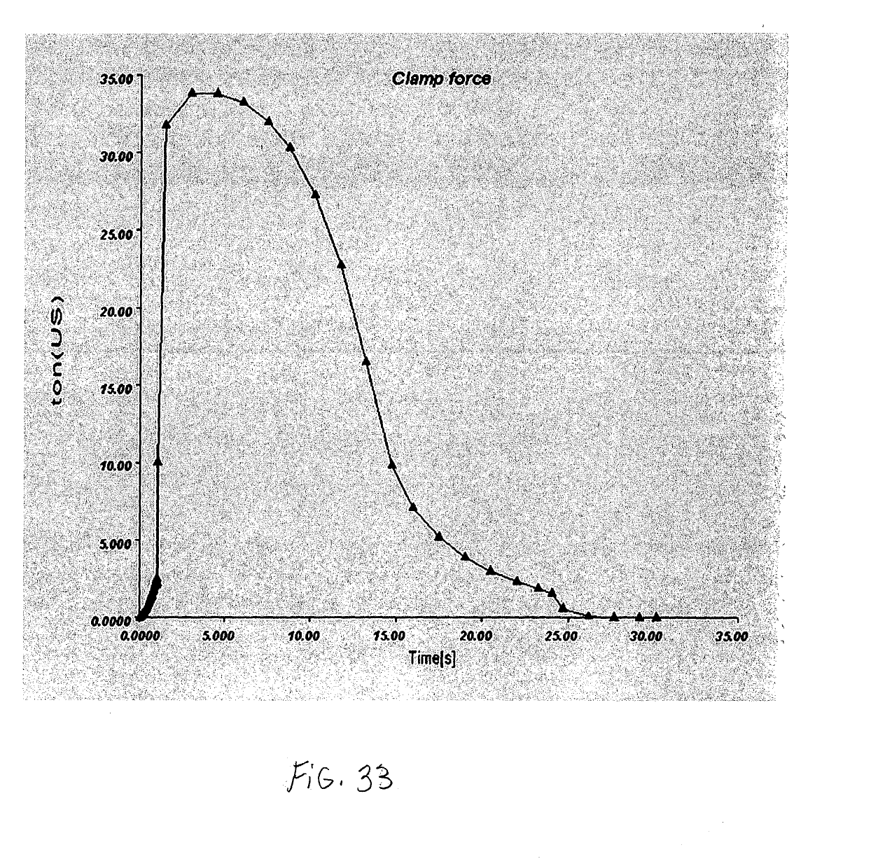

FIG. 33 shows an example of a plot or graph output of a simulation program according to the invention showing in particular a variation in clamp force of the mold over the course of a simulated injection cycle.

Plots, graphs, two and three dimensional still or moving images (time successive images) and other calculated properties, states, characteristics and operating parameters of the fluid flow, the injection apparatus and the injected part can be generated by a simulation algorithm of the invention. Some of the most common data calculable by a program according to the invention are temperature of the flow material and injection apparatus, flow material pressure, flow rate, flow time, flow material shear rate, flow material shear stress, flow material sink index, flow material shrinkage, location and existence of air pockets and location and existence of weld lines in the part. Such data may be generated for a property, state or characteristic as it exists at any single instant in time or during any interval in a cycle time. Such data may also be generated for a property, state or characteristic as it exists at any selected locations in the flow channels of the injection apparatus.

Given the ability of the user of the invention to control the local rate of fluid flow through any one or more injection ports leading to any one or more mold cavities, the simulation program of the invention includes instructions for processing data indicative of fluid flow through any one or a plurality of injection ports during a single injection cycle. For example, with reference to FIG. 1, fluid flow data associated with each individual injection port 7 and 9, both leading to a single cavity 5, is processable to produce a simulation of a single injection cycle With reference to FIG. 28A, fluid flow data 1040, 1042 associated with ports 1030, 1032 (leading to a single cavity 1036) and fluid flow data 1044 associated with port 1034 (leading to a separate cavity 1038) are processable together to produce a simulation of a single injection cycle for both cavities 1036. With reference to FIG. 28B, fluid flow data 1054, 1064, 1074, 1084 associated with each port 1050, 1060, 1070, 1080 is processable to produce a simulation of a single injection cycle for the four separate cavities 1052, 1062, 1072 and 1082.

Once a simulation of an injection cycle has been generated, the user may vary the flow rate data for each injection port to attempt to achieve a set of operating parameters that produce a molded part of optimum quality and/or to determine a set of optimum operating parameters. For example, based on a simulation using a first set of variable inputs, the user may then evaluate the data to determine, based on experience and less desirable aspects of the simulation, whether to change one or more of the variable inputs attempt to improve or otherwise change the generated simulation data. For example, the user/operator may decide to change the profile of the flow rate, change the composition of the fluid material or another operating parameter of the injection apparatus such as temperature of a component of the apparatus or the mold, ram pressure or velocity or the like. Once a simulation is generated the user may then implement the changed variable inputs to the program in actual operating runs of the injection apparatus. Or, the user may implement further changes or variations in the previously changed variables as new inputs to the simulation program to generate another simulation and again re-evaluate the newly generated simulation. Some of the most common features of a simulation output that a user/operator may typically attempt to improve are:

cavity fill time, pack time, hold time, cool time

the number and size of air pockets in the molded part or flow channels

high stress locations in the molded part

high shear locations in the molded part

As described above with reference to the examples of FIGS. 1-18, the invention provides apparati and methods for automated control of a flow controlling mechanism via a computer or other algorithm processor. The user/operator may utilize the data obtained from the simulation program of the invention as an input to the control algorithm described with reference to FIGS. 1-18. In particular, the data indicative of flow rate which may be derived from the simulation program is useful to an operator of the injection apparatus because such data may be input as a target pressure or flow profile that the control computer uses to operate the valve pins during the course of an injection cycle.

The invention also provides a method and program for automatically generating one or more optimized operating parameters used in an injection cycle carried out by an injection molding apparatus having an injection unit for injecting fluid from an exit of a barrel into a manifold delivering the fluid to at least two injection ports leading to one or more cavities of one or more molds; the system comprising a set of instructions that generate a calculated property, state, position or image of the fluid flowing into or through each cavity, the one or more programs using one or more estimated variable inputs that are representative of one or more selected properties, characteristics or operating parameters of the apparatus or the fluid; the estimated variable inputs comprising at least a first value indicative of a first fluid flow rate independently controllable downstream of the barrel exit leading to or through a first injection port and a second value indicative of a second fluid flow rate independently controllable downstream of the barrel exit leading to or through a second injection port; the system further comprising a set of instructions that automatically vary one or more of the variable inputs to generate a calculation of an optimized value for one or more selected ones of the variable inputs.

The estimated variable inputs are typically one or more of injection unit temperature, injection unit fluid injection rate, injection unit fluid pressure, fluid flow rate through one of the at least two injection ports, fluid flow rate through the other of the at least two injection ports, fluid pressure through one of the at least two injection ports, fluid pressure through the other of the at least two injection ports, shear rate of the fluid, shear value of the fluid, melt temperature of the fluid, freezing point of the fluid, molecular weight of the fluid, density of the fluid, mold temperature, manifold temperature, injection nozzle temperature and injection cycle time.

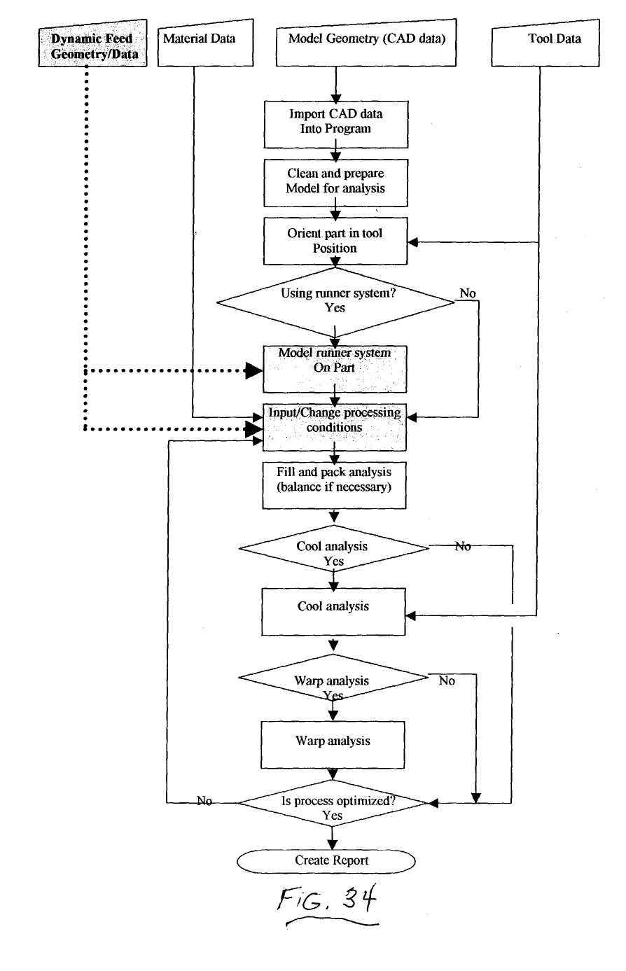

FIG. 34 shows a typical set of steps that can be used in or in conjunction with a simulation program or system according to the invention. The term geometry in FIG. 34 refers to or means computer assisted design data as is typically generated using two or three dimensional design programs such as ProEngineer or Solidworks. As shown in FIG. 34 geometry data for the mold cavity, manifold channels, injection nozzles and valves is preferably input into the simulation program. The term “dynamic feed” as used in FIG. 34 refers to those valves, bores, flow controllers and flow rate parameters that are located downstream of the exit of the barrel of injection unit. CAD data for the downstream dynamic feed valve, bores, channels is preferably input into the program together with CAD data for the mold cavity and manifold channels. CAD data for the injection unit barrel and other components of the injection molding system may also be input to the simulation program. As shown Dynamic Feed data is also input to the simulation program, i.e. data which is indicative of fluid flow rate that is controlled downstream of the exit of the barrel of the injection unit. Dynamic Feed data typically comprises a profile of fluid pressure over an entire injection cycle within the downstream bores. As described above, any data indicative of fluid flow rate, such as the position of a downstream fluid flow controller (e.g. a valve pin) may also be used as the Dynamic Feed data input.

In FIG. 34, the simulation program is primarily carried out to generate a simulated injection cycle between the “Input/Change processing conditions” step and the “create report” steps.

FIG. 34 shows a step labeled “Input/Change processing conditions.” This step can be carried out manually as described above where the user determines an a set of downstream fluid flow rates by trial and error operation of an injection molding system or estimates such parameters from experience with the same or similar system that is to be simulated by the program. Alternatively, a program according to the invention can include a set of instructions that automatically change the Dynamic Feed data that is initially input to the program to produce a resultant simulation output that achieves one or more predetermined or predefined optimal or optimized results, such as minimized cavity fill time, or a specified location of weld line, or a minimized shear or stress value formed in certain portions the formed part or any other desired part property or operating parameter. Such predefined optimal results/objectives of the simulation can be input at the same step/stage as the box labeled “Input/Change processing conditions.”

As shown in FIG. 34, a final decision triangle labeled “Is process optimized” may be included as a function in a program according to the invention. In such an embodiment, the simulation program generates a resultant simulation of data and compares it to the predefined optimal data, and if the generated simulation does not match (i.e. invoking the “No” branch of the decision triangle), the program automatically reverts to changing the dynamic feed processing conditions data by some amount that will generate a simulation that comes closer to matching or matches the predefined or preselected optimal result, condition, operating parameter of the simulated injection cycle. Thus, an optimized set of operating parameters for an injection cycle can be generated by automatically varying/changing the Dynamic Feed inputs to the simulation program until a simulation output is achieved that meets/matches one or more predefined results. As can be readily imagined, the input of new data at the stage of “Input/Change processing conditions” may be determined by the operator based on experience.

The step/decision labeled “Is process optimized?” in FIG. 34 may be omitted altogether and a resultant simulation report, image or the like can be generated in any event without any attempt to achieve a predefined optimum.

What is claimed is:

1. A system for generating a simulation of fluid flow in an injection molding process carried out by an injection molding machine having an injection unit for injecting the fluid from an exit of a barrel into a manifold delivering the fluid to at least two injection ports leading to one or more cavities of one or more molds;
the system comprising one or more programs containing a set of instructions that generate a calculated property, state, position or image of the fluid flowing into or through each cavity, the one or more programs using one or more variable inputs that are representative of one or more selected properties, characteristics or operating parameters of the machine or the fluid;
the variable inputs comprising at least a first value indicative of a first fluid flow rate downstream of the barrel exit leading to or through a first injection port and a second value indicative of a second fluid flow rate downstream of the barrel exit leading to or through a second injection port.

2. The system of claim 1 wherein the first value is determined according to the first fluid flow rate being independent of the second flow rate and the second value is determined according to second flow rate being independent of the first flow rate.

3. The system of claim 1 wherein the first value comprises a first profile or series of values indicative of the first flow rate leading to or through the first injection port over the course of an injection cycle independent of fluid flowing to or through the second injection port, and wherein the second value comprises a second profile or series of values indicative of the second flow rate over the course of the injection cycle independent of fluid flowing to or through the first injection port.

4. The system of claim 1 wherein the first and second values are determined from a pressure value of the fluid flowing through first and second channels leading to the first and second injection ports respectively.

5. The system of claim 1 wherein the first value comprises a first profile or series of values indicative of a flow rate leading to or through the first injection port over a period of time of filling of the one or more cavities and a flow rate over a subsequent period of time during which the one or more cavities is being packed.

6. The system of claim 5 wherein the second value comprises a second profile or series of values indicative of a flow rate leading to or through the second injection port over a period of time of filling of the one or more cavities and a flow rate over a subsequent period of time during which the one or more cavities is being packed.

7. A method for generating a simulation of fluid flow in an injection molding process carried out by an injection molding machine having an injection unit for injecting the fluid into a manifold delivering the fluid to at least two injection ports leading to one or more cavities, the method comprising:
calculating a property, state, position or image of the fluid flowing into or through each cavity using a program which uses one or more variable inputs that are representative of one or more selected properties, characteristics or operating parameters of the machine or the fluid;
inputting to the program variable inputs that comprise at least a first value indicative of a fluid flow rate downstream of the injection unit leading to or through a first injection port to the one or more cavities and a second value indicative of a fluid flow rate downstream of the injection unit leading to or through a second injection port to the one or more cavities.

8. The method of claim 7 wherein the first value is determined according to the first fluid flow rate being independent of the second flow rate and the second value is determined according to second flow rate being independent of the first flow rate.

9. The method of claim 7 wherein the first value comprises a first profile or series of values indicative of the first flow rate leading to or through the first injection port over the course of an injection cycle independent of fluid flowing to or through the second injection port, and wherein the second value comprises a second profile or series of values indicative of the second flow rate over the course of the injection cycle independent of fluid flowing to or through the first injection port.

10. The method of claim 7 wherein the first and second values are determined from a pressure value of the fluid flowing through first and second channels leading to the first and second injection ports respectively.

11. The method of claim 7 wherein the first value comprises a first profile or series of values indicative of a flow rate leading to or through the first injection port over a period of time of filling of the one or more cavities and a flow rate over a subsequent period of time during which the one or more cavities is being packed.

12. The method of claim 7 wherein the second value comprises a second profile or series of values indicative of a flow rate leading to or through the second injection port over a period of time of filling of the one or more cavities and a flow rate over a subsequent period of time during which the one or more cavities is being packed.

13. A system for generating a simulation of fluid flow in an injection molding process carried out by an injection molding machine having an injection unit for injecting the fluid into a manifold that delivers the fluid to first and second injection ports that are independently controllable to control rate of fluid flow through each port into one or more cavities of one or more molds, the system comprising:
a mechanism that generates a calculated property, state, position or image of the fluid flowing into or through the one or more cavities comprising a program that uses one or more variable inputs that are representative of one or more selected properties, characteristics or operating parameters of the machine or the fluid;
wherein the program includes a set of instructions for processing as an input a first value indicative of a first rate of fluid flow downstream of the injection unit leading to or through the first injection port to generate a calculated property, state, position, characteristic or image of the fluid flowing into or through the one or more cavities, and,
wherein the program includes a set of instructions for processing as an input a second value indicative of a second rate of fluid flow downstream of the injection unit leading to or through the second injection port to generate a calculated property, state, position, characteristic or image of the fluid flowing into or through the one or more cavities.

14. The system of claim 13 wherein the first and second values indicative of the first and second rates of fluid flow respectively are determined independently of each other.

15. The system of claim 13 wherein the first value comprises a first profile or series of values indicative of fluid flow rate over the course of an injection cycle and the second value comprises a second profile or series of values indicative of fluid flow rate over the course of the injection cycle.

16. The system of claim 13 wherein the first and second values are determined from a pressure value of the fluid flowing through first and second channels leading to the first and second injection ports respectively.

17. A method for generating a simulation of fluid flow in an injection molding process carried out by an injection molding machine having an injection unit for injecting the fluid into a manifold that delivers the fluid to an injection port to a cavity of a mold, the flow to the injection port being independently controllable downstream of the injection unit to control rate of fluid flow through the injection port, the method comprising:
calculating a property, state, position or image of the fluid flowing into or through the cavity using a program which uses one or more variable inputs that are representative of one or more selected properties, characteristics or operating parameters of the machine or the fluid;
inputting as a first variable input to the program a first value indicative of a first rate of fluid flow leading to or through the injection port over a period of time during filling of the cavity, and,
inputting as a second variable input to the program a second value indicative of a second rate of fluid flow leading to or through the injection port over a period of time following filling of the of the cavity.

18. The method of claim 17 wherein the first variable input comprises a profile or series of values indicative of the first rate of fluid flow over the period of time during filling of the cavity, and the second variable input comprises a profile or series of values indicative the second rate of fluid flow over the period of time following filling of the cavity.

19. A system for simulating a flow of fluid into or through one or more cavities of one or more molds in an injection molding apparatus, the apparatus having a manifold with channels leading to first and second injection ports to the one or more cavities and an injection unit for delivering fluid to the manifold, the system comprising:
a program that generates a simulation of fluid flow into or through the one or more cavities;
the program having a first set of instructions for processing a first data set;
the first data set comprising a set of values representative of a first fluid flow rate leading to or through the first injection port during an injection cycle, wherein the first fluid flow rate is selectively controllable downstream of the injection unit;
the program having a second set of instructions for processing a second data set;
the second data set comprising a set of values representative of a second fluid flow rate leading to or through the second injection port during the injection cycle, wherein the second fluid flow rate is selectively controllable downstream of the injection unit.

20. The system of claim 19 wherein the first data set comprises values representative of the first fluid flow rate during a period of time when the one or more mold cavities are being filled and data representative of the first fluid flow rate during a period time following the period of time when the one or more mold cavities are being filled.

21. A system for simulating a flow of fluid material into or through one or more cavities of one or more molds in an injection molding apparatus, the apparatus having a manifold with channels leading to an injection port to the one or more cavities and an injection unit for delivering fluid to the manifold, the system comprising:
a program that generates a simulation of fluid flow into or through the one or more cavities;
the program having a set of instructions for processing first and second data sets to generate the simulation;
the first and second data sets comprising a set of values representative of a fluid flow rate leading to or through the injection port at a flow controllable position downstream of the machine barrel;
the first data set comprising a set of values indicative of the fluid flow rate over a period of time of a single injection cycle when the one or more cavities are being filled with the fluid material;
the second data set comprising a set of values indicative of the fluid flow rate over a period of time following the time when the one or more cavities are being filled with the fluid material.

22. The system of claim 21 wherein the second data set comprises one or more sets of values indicative of the fluid flow rate subsequent to filling of the one or more cavities during which the fluid material is being packed or held or cooled within the one or more mold cavities.

23. The system of claim 21 wherein the second data set comprises values representative of the second fluid flow rate during a period of time when the one or more mold cavities are being filled and data representative of the second fluid flow rate during a period time following the period of time when the one or more mold cavities are being filled.

24. A system for automatically generating one or more optimized operating parameters used in an injection cycle carried out by an injection molding apparatus having an injection unit for injecting fluid from an exit of a barrel into a manifold delivering the fluid to at least two injection ports leading to one or more cavities of one or more molds;
the system comprising a set of instructions that generate a calculated property, state, position or image of the fluid flowing into or through each cavity, the one or more programs using one or more estimated variable inputs that are representative of one or more selected properties, characteristics or operating parameters of the apparatus or the fluid;
the estimated variable inputs comprising at least a first value indicative of a first fluid flow rate independently controllable downstream of the barrel exit leading to or through a first injection port and a second value indicative of a second fluid flow rate independently controllable downstream of the barrel exit leading to or through a second injection port;
the system further comprising a set of instructions that automatically vary one or more of the variable inputs to generate a calculation of an optimized value for one or more selected ones of the variable inputs.

25. The system of claim 24 wherein the estimated variable inputs are one or more of injection unit temperature, injection unit fluid injection rate, injection unit fluid pressure, fluid flow rate through one of the at least two injection ports, fluid flow rate through the other of the at least two injection ports, fluid pressure through one of the at least two injection ports, fluid pressure through the other of the at least two injection ports, shear rate of the fluid, shear value of the fluid, melt temperature of the fluid, freezing point of the fluid, molecular weight of the fluid, density of the fluid, mold temperature, manifold temperature, injection nozzle temperature and injection cycle time.
